(19) United States
(12) Patent Application Publication
(10) Pub. No.: US 2012/0198848 A1
(43) Pub. Date: Aug. 9, 2012

(54) POWER PRODUCTION FROM COMPRESSED GAS WITH THE AID OF MOMENT OF INERTIA BY POWER PRODUCTION APPARATUS

(76) Inventor: Mustafa Dayanik, Antalya (TR)

(21) Appl. No.: 13/501,443

(22) PCT Filed: Oct. 8, 2010
(86) PCT No.: PCT/IB10/54556

§ 371 Date: Apr. 11, 2012

(30) Foreign Application Priority Data
Oct. 12, 2009 (TR) 2009/07688

(51) Int. Cl. F03G 7/00

(52) U.S. Cl. 60/716

(57) ABSTRACT

This system, consists of mainly two parts which are power production apparatus by moment of inertia principle and closed compressor system. The apparatus converts the linear force applied on it or rotational motion to oscillation motion and transfers it to massive element (10). This massive element (10) converts the moment of inertia force created by skidding action with two-centered motion to rotational motion. The accelerated compressor of the apparatus with the oscillation motion of hammer element (2) uses the pressure of compressed air in its chamber (27) and acts as a machine of two cylinder. This continuous oscillation motion thus created with this system is converted to rotational motion by this apparatus. This system can be used in all kinds of system which produce work and energy.

This new technology is the conversion of potential energy of compressed gas with the aid of moment of inertia without any chemical reaction with the aid of moment of inertia linear force is directly converted to rotational motion.

The existent technology makes it possible to convert the linear force to rotational motion by crank shafts. Crank shaft is in fact an eccentric shaft which converts back and forth movement of pistons to rotational motion. The magnitude of linear force affects the rotational motion. The crank shaft is the most important and expensive element of all kinds of machine. Any defect of this shaft creates big problems and it is very difficult to overcome these difficulties.

Another type of system on the other hand is a piston system which moves up and down on a control axis which then is converted to rotational motion by circular lay profile. With this system conversion of linear force to rotation is possible, but created rotational motion cannot be enforced. On the other hand since there are many parts, erosion and frictional losses create problems and production problems exist. The volume and weight of the system are considerable.

The power created by moment of inertia of compressed gas by the power production apparatus is directly converted to rotational motion and hence energy is saved. The potential energy of compressed gas is converted to kinetic energy without chemical reaction. The aim is renewable energy.

The schematic diagrams of the power production apparatus are shown separately. The ideal dimensions are shown by symbol (a). The figures are as follows.

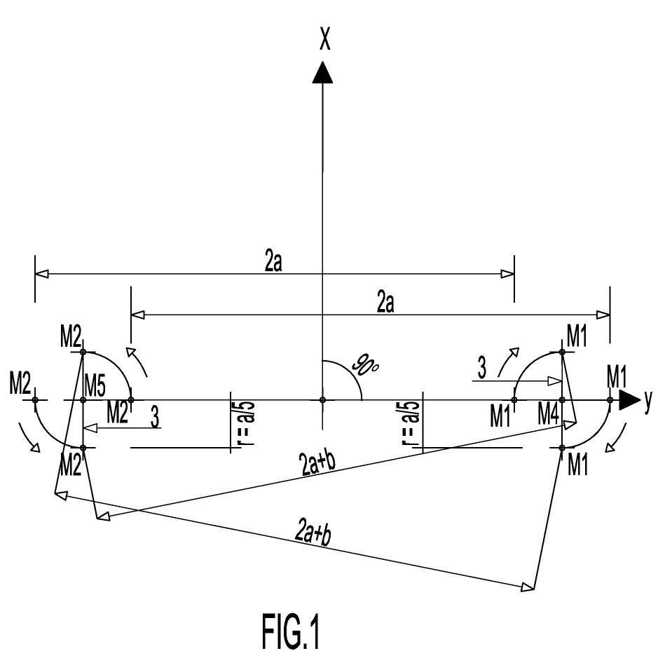

FIG. 1—(M1, M4)=(a/5) and (M2, M5)=(a/5) (M1) is the eccentric center of eccentric element(3) at (M4). (M2) is the eccentric center of eccentric element(3) at (M5). The horizontal distance between (M1) and (M2) is (2a). The distance between (M4 and M5) is also (2a). When the eccentric element(3) at (M4) and (M5) are rotated 90° in the opposite direction, the distance between (M1 and M2) is (2a+b). When (M1) is fixed, the slipping distance is the slippage at (M2). When the eccentrics(3) are rotated 270°, the distance between (M1) and (M2) is also (2a+b). When (M2) is fixed, the slipping distance is the slippage at (M1). For this reason slipping tolerances must be applied at both centers.

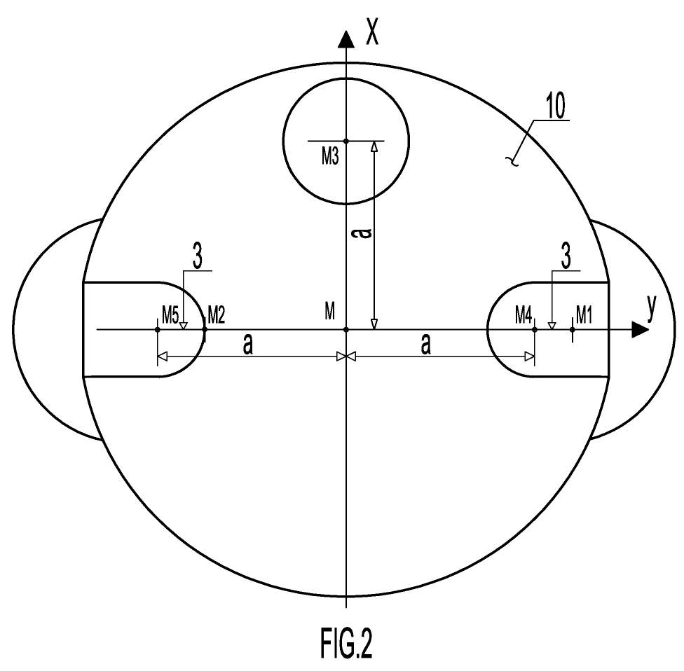

FIG. 2—(M) is the center of gravity of disc element(10) which is the intersection of (x) and (y) coordinates. The distance between (M4),(M5) which are the revolving center of eccentric element(3) and (M) and also the distance of (M3) center of disc element(10) and (M) are the same and equal to (a). The center of revolving point of the disc element(10) is at the distance of revolving point of eccentric elements(10). The distance of (M1,M4) and (M2,M5) are the spin off distance of the reverse revolving motion of eccentric element(3).

According to the reverse movement of eccentric element(3), determination of the diagram followed by (M3) point of disc element(10);

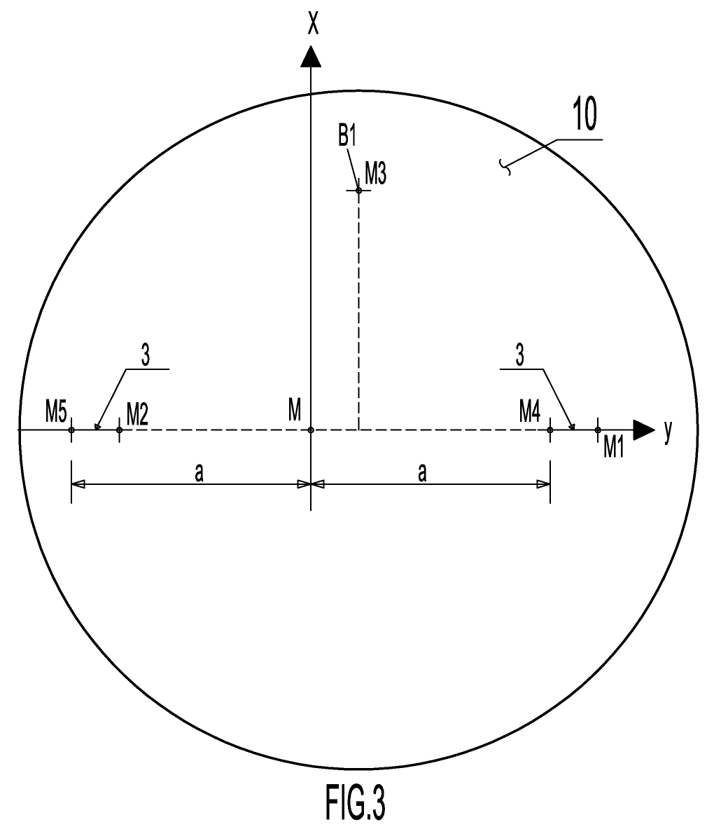

FIG. 3—Eccentric centers of eccentric element(3) centered at (M4) and (M5) and (M1), (M2) centers of disc element(10) are located on intersection of (y) axis. The distance of (M4), (M5) to the point (M) which is the intersection of (x) and (y) are the same. (B1) is the starting point of the diagram followed by (M3) on two centered movement of disc element(10) by eccentric element(3) which rotates in reverse direction.

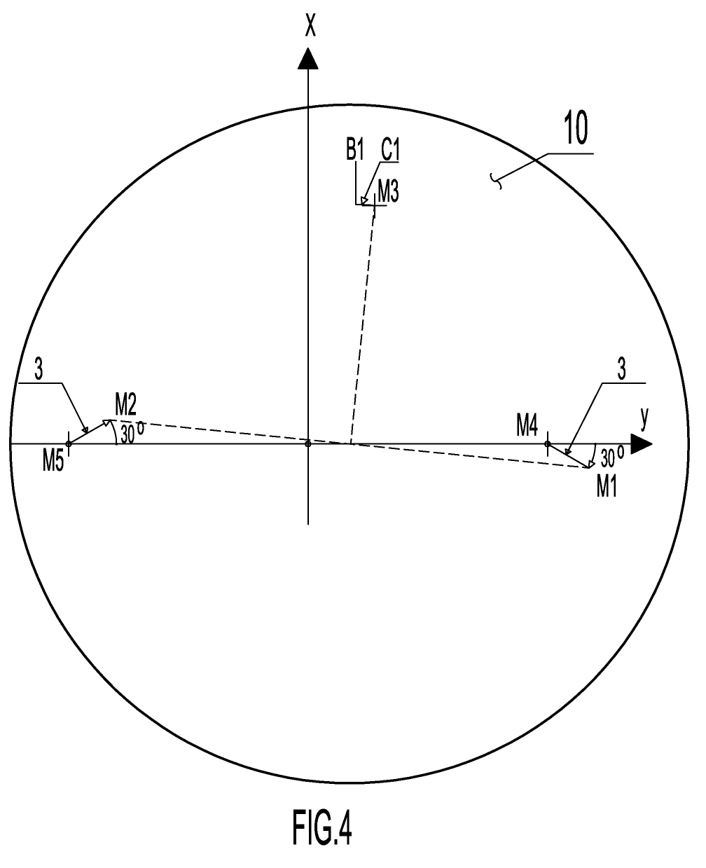

FIG. 4—The eccentric element(3) the centers of which at (M4) and (M5) when rotated 30° in the opposite direction, (M3) center of disc element(10) follows (C1) diagram starting from point (B1).

FIG. 5—The eccentric element(3) the centers of which at (M4) and (M5) when rotated 45° in the opposite direction, the center of (M3) of disc element(10) follows (C2) diagram starting from point (B1).

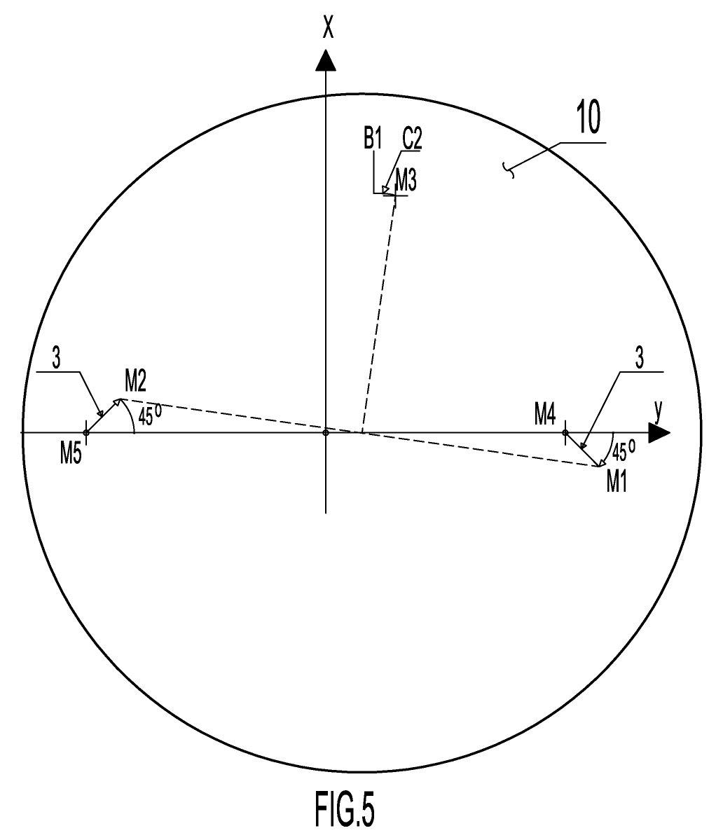

FIG. 6—The eccentric element(3) the centers of which at (M4) and (M5) when rotated 60° in the opposite direction, the center of (M3) of disc element(10) follows (C3) diagram starting from point (B1).

FIG. 7—The eccentric element(3) the centers of which at (M4) and (M5) when rotated 90° in the opposite direction, the center of (M3) of disc element(10) follows (C4) diagram starting from point (B1). lets define this point as (B3) when 90° rotation is completed.

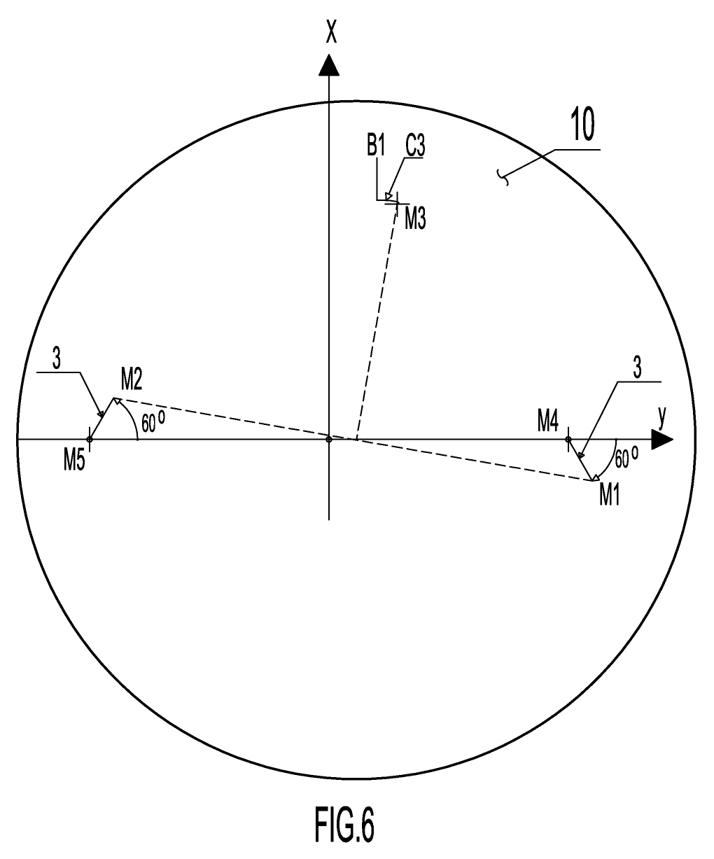

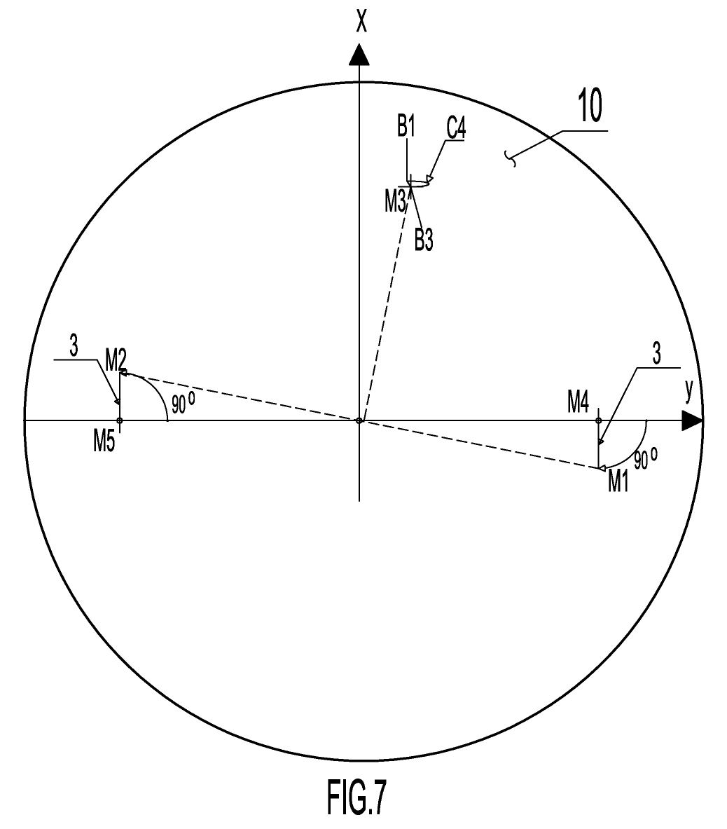

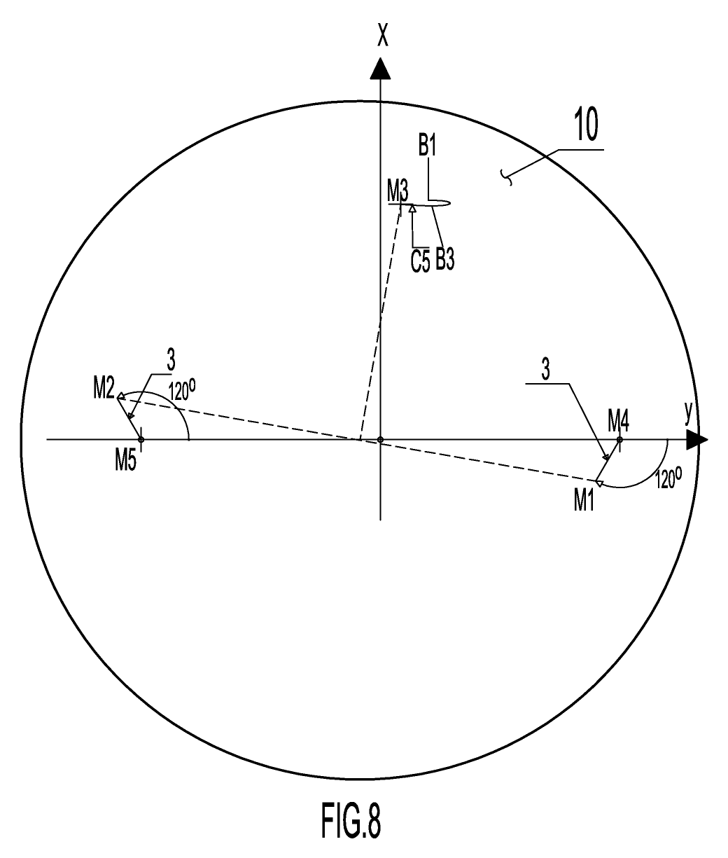

FIG. 8—The eccentric element(3) the centers of which at (M4) and (M5) when rotated 120° in the opposite direction, the center of (M3) of disc element(10) follows (C5) diagram starting from point (B1).

FIG. 9—The eccentric element(3) the centers of which at (M4) and (M5) when rotated 136.625° in the opposite direction, the center of (M3) of disc element(10) follows (C6) diagram starting from point (B1).

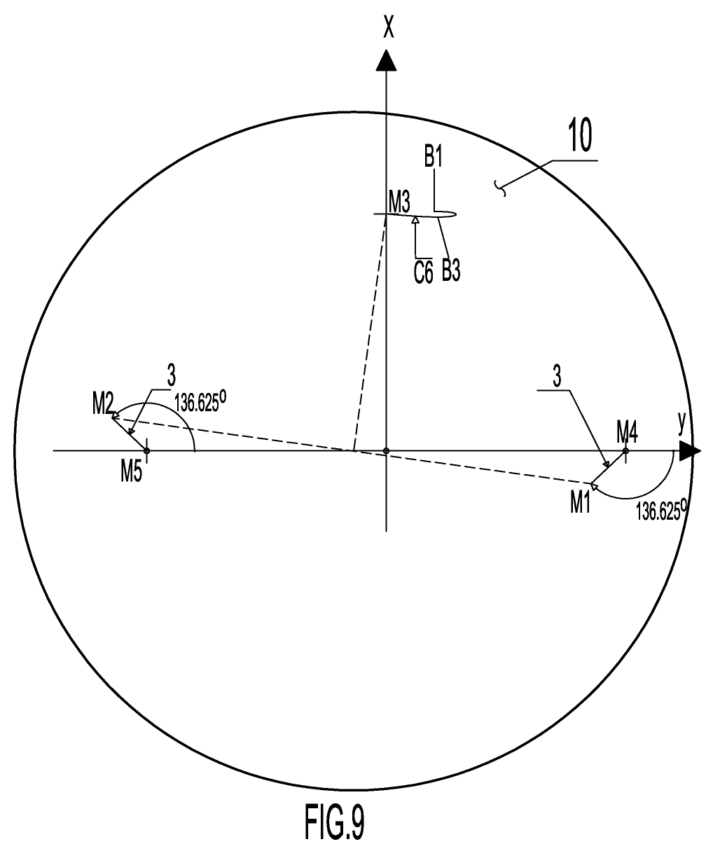

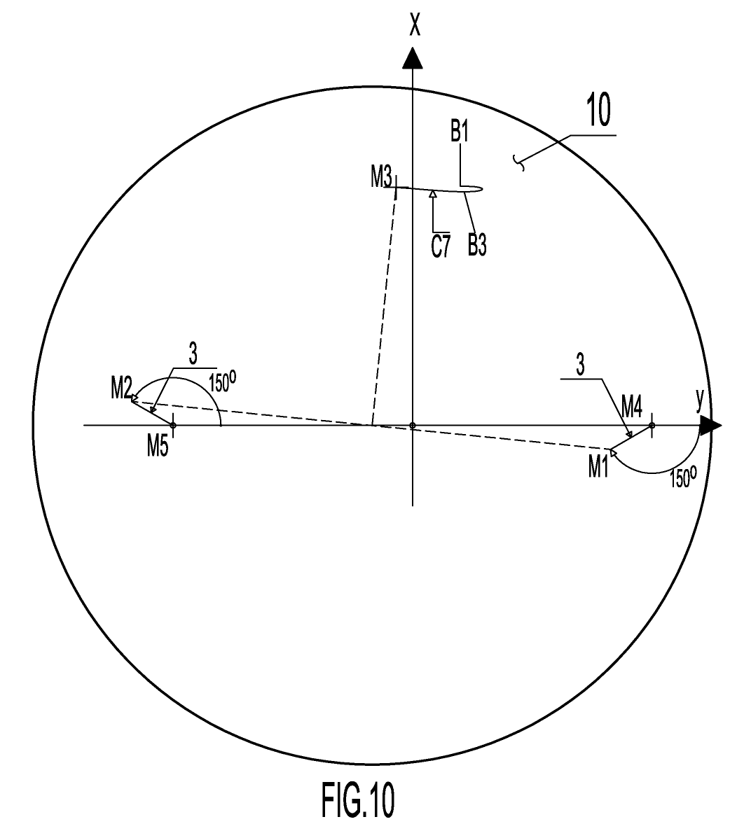

FIG. 10—The eccentric element(3) the centers of which at (M4) and (M5) when rotated 150° in the opposite direction, the center of (M3) of disc element(10) follows (C7) diagram starting from point (B1).

FIG. 11—The eccentric element(3) the centers of which at (M4) and (M5) when rotated 180° in the opposite direction, the center of (M3) of disc element(10) follows (C8) diagram starting from point (B1). lets define this point as (B2) when 180° rotation is completed.

FIG. 12—The eccentric element(3) the centers of which at (M4) and (M5) when rotated 210° in the opposite direction, the center of (M3) of disc element(10) follows (C9) diagram starting from point (B1).

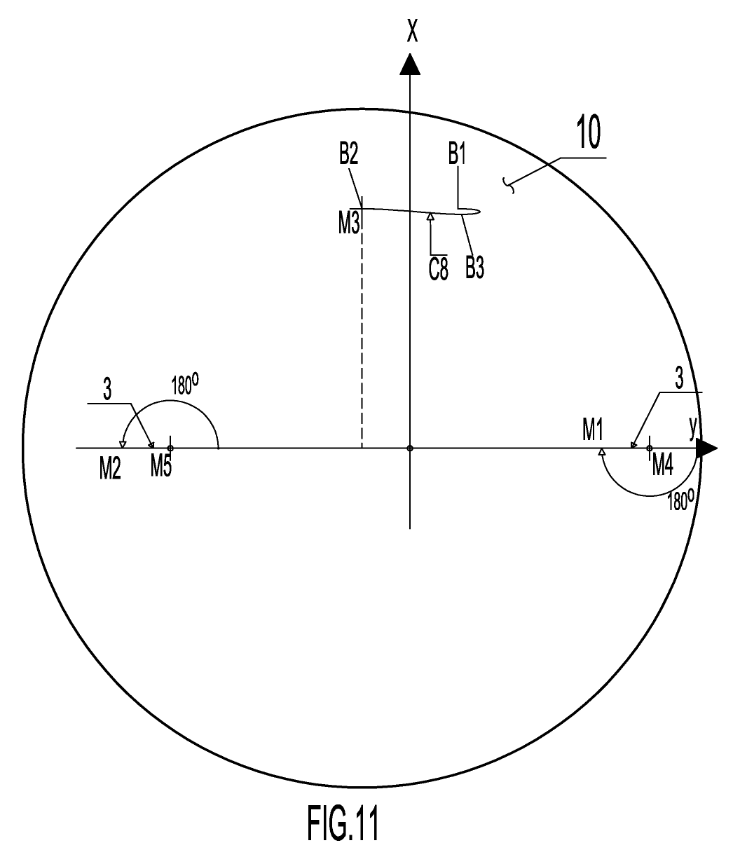

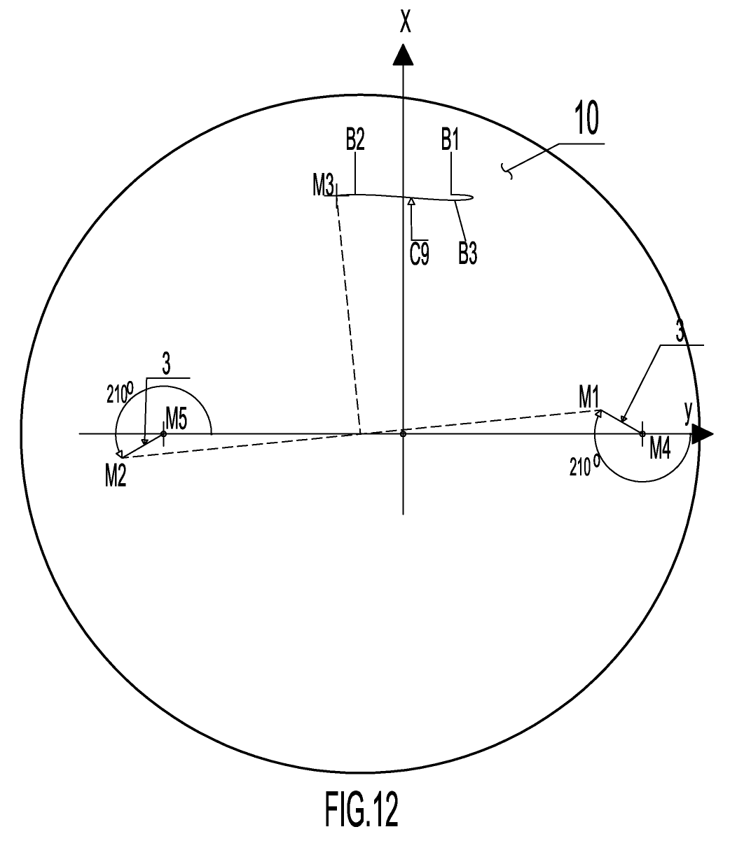

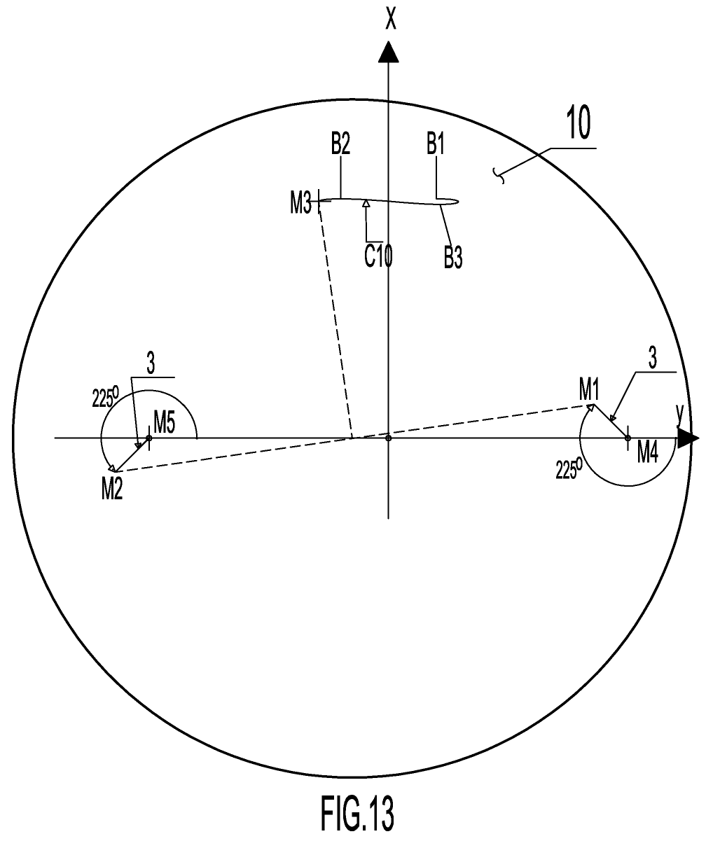

FIG. 13—The eccentric element(3) the centers of which at (M4) and (M5) when rotated 225° in the opposite direction, the center of (M3) of disc element(10) follows (C10) diagram starting from point (B1).

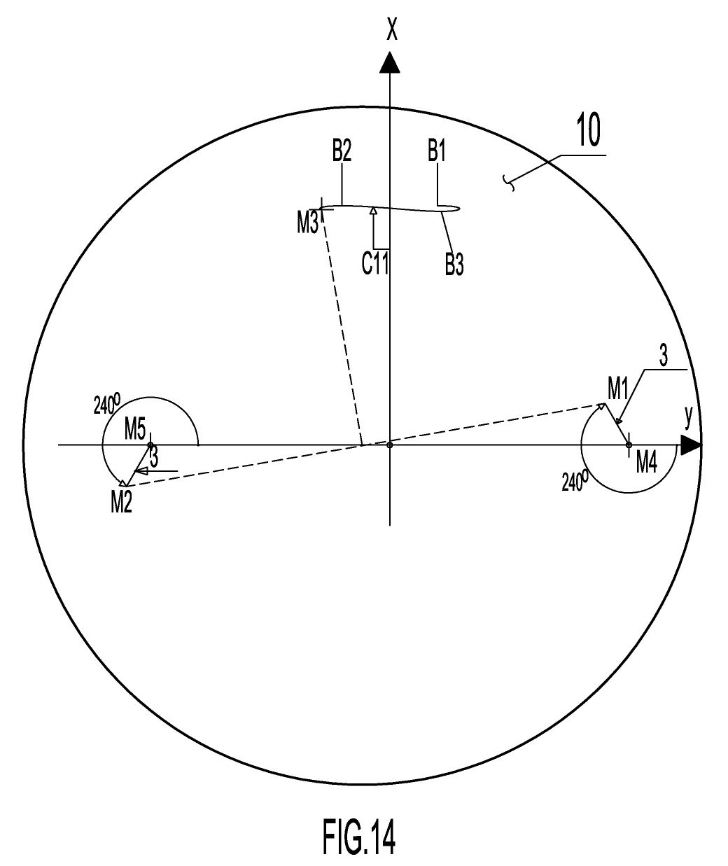

FIG. 14—The eccentric element(3) the centers of which at (M4) and (M5) when rotated 240° in the opposite direction, the center of (M3) of disc element(10) follows (C11) diagram starting from point (B1).

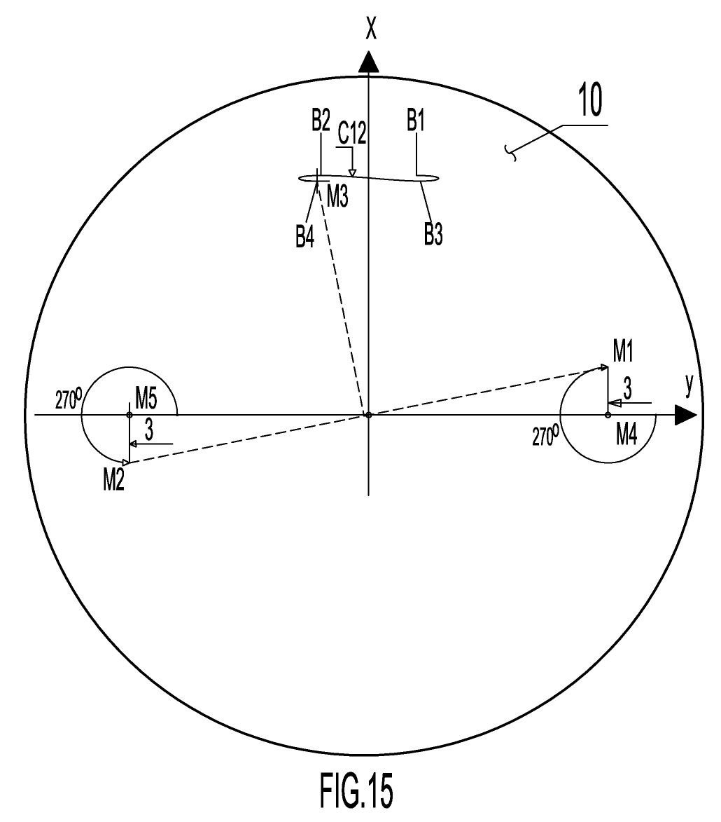

FIG. 15—The eccentric element(3) the centers of which at (M4) and (M5) when rotated 270° in the opposite direction, the center of (M3) of disc element(10) follows (C12) diagram starting from point (B1). lets define this point as (B4) when 270° rotation is completed.

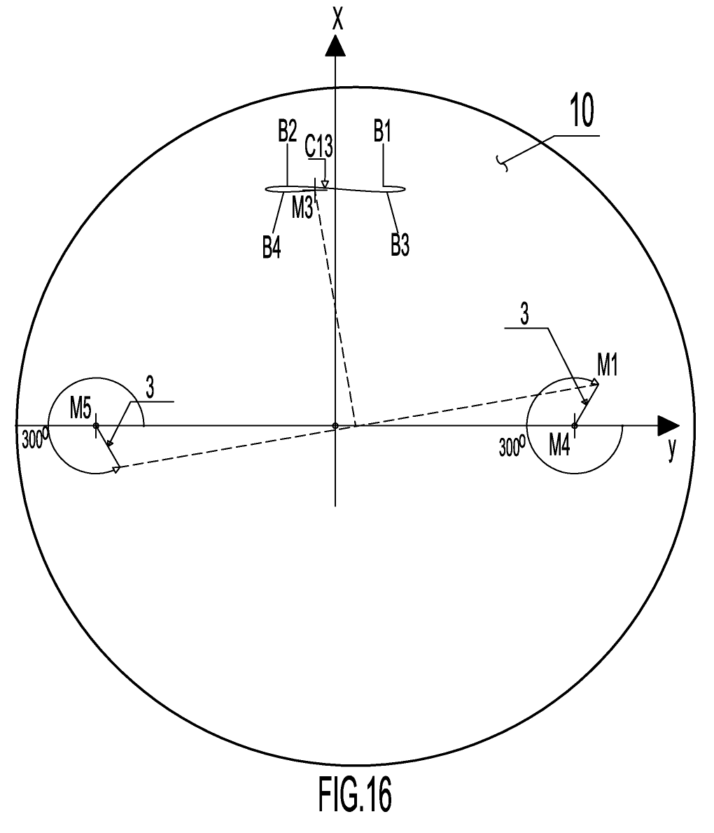

FIG. 16—The eccentric element(3) the centers of which at (M4) and (M5) when rotated 300° in the opposite direction, the center of (M3) of disc element(10) follows (C13) diagram starting from point (B1).

FIG. 17—The eccentric element(3) the centers of which at (M4) and (M5) when rotated 316.625° in the opposite direction, the center of (M3) of disc element(10) follows (C14) diagram starting from point (B1).

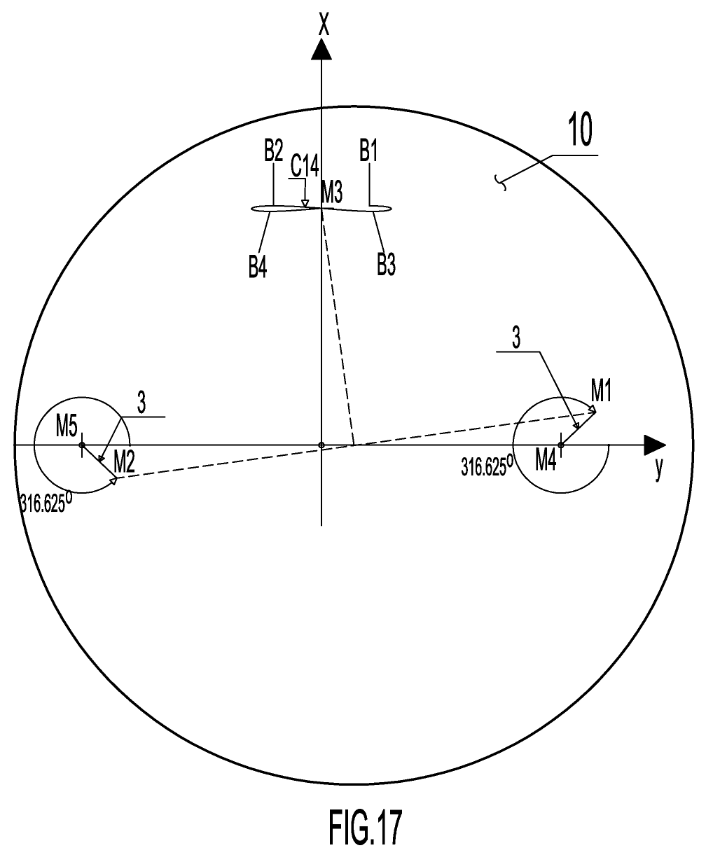

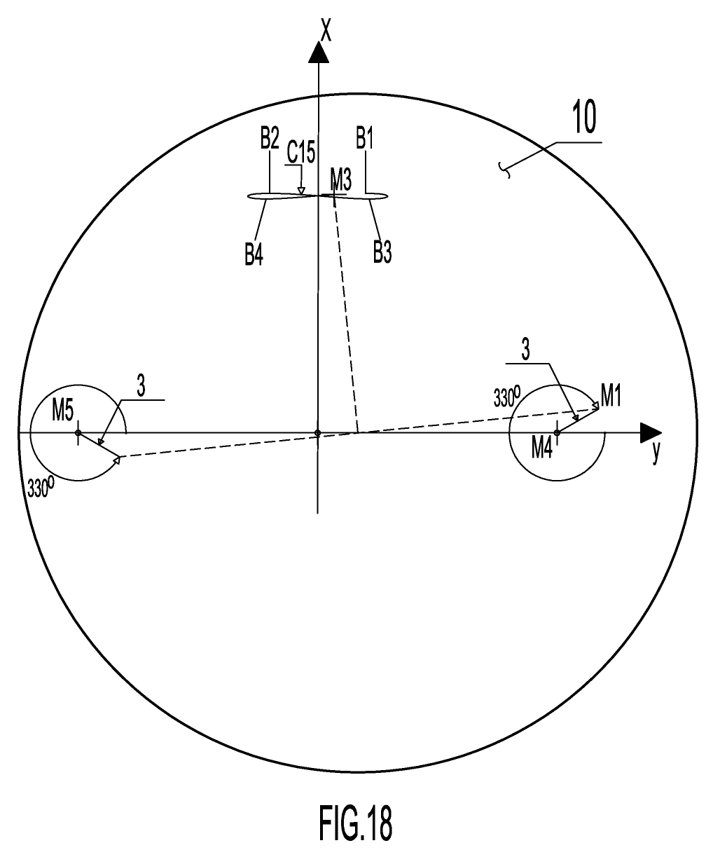

FIG. 18—The eccentric element(3) the centers of which at (M4) and (M5) when rotated 330° in the opposite direction, the center of (M3) of disc element(10) follows (C15) diagram starting from point (B1).

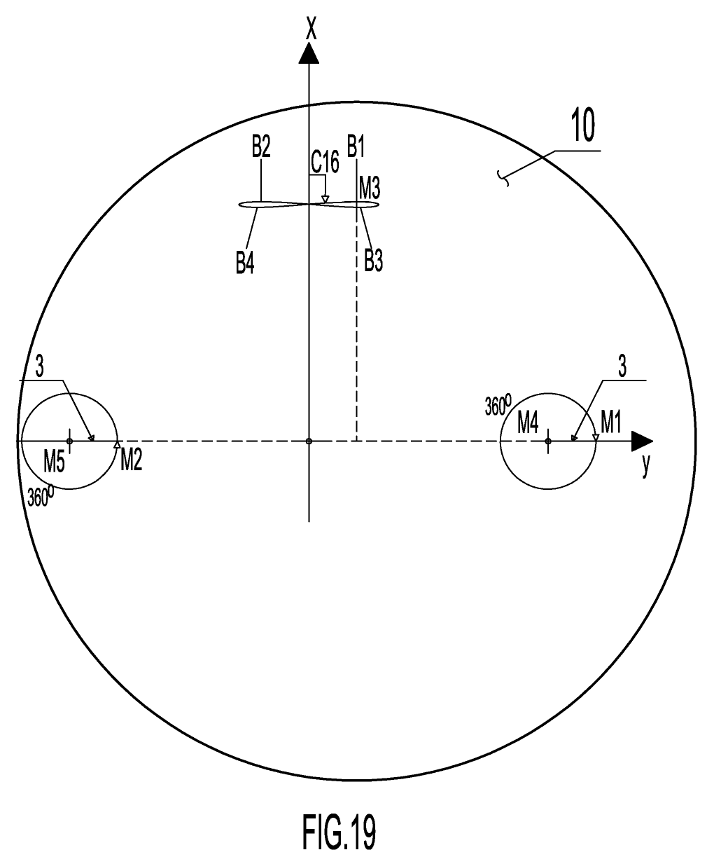

FIG. 19—The eccentric element(3) the centers of which at (M4) and (M5) when rotated 360° in the opposite direction, (M3) center of disc element(10) follows (C16) diagram starting from point (B1) and the starting point coincides with (B1). This is the diagram of point (M3) in a cycle and is fixed at each cycle.

The recognizing the distance of eccentric of shuttle element.

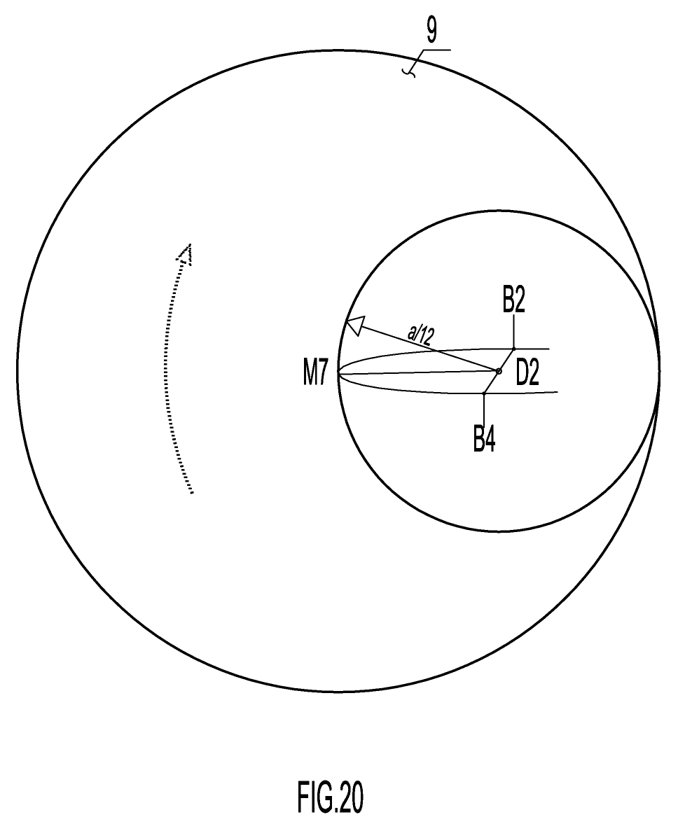

FIG. 20—Point (B2) is the end point when 180 degree rotation is completed. The points (B2) and (B4) is on the other hand the diagram of 90 degree rotation. The distances the center of shuttle element(9) to (B2) and to (B4) must be equal which are the starting and final points of 90° diagram. The part of eccentric center of shuttle element(9) is a diagram, the radius of the circle which is forget at (D2) is the eccentric slipping distance of shuttle element(9). This distance is (r=a/12). The position of shuttle element(9) in the axis (D2) and (M7) is the final point of counter clock-wise rotation the center of which is (D2). This is also the starting point of clock-wise rotation.

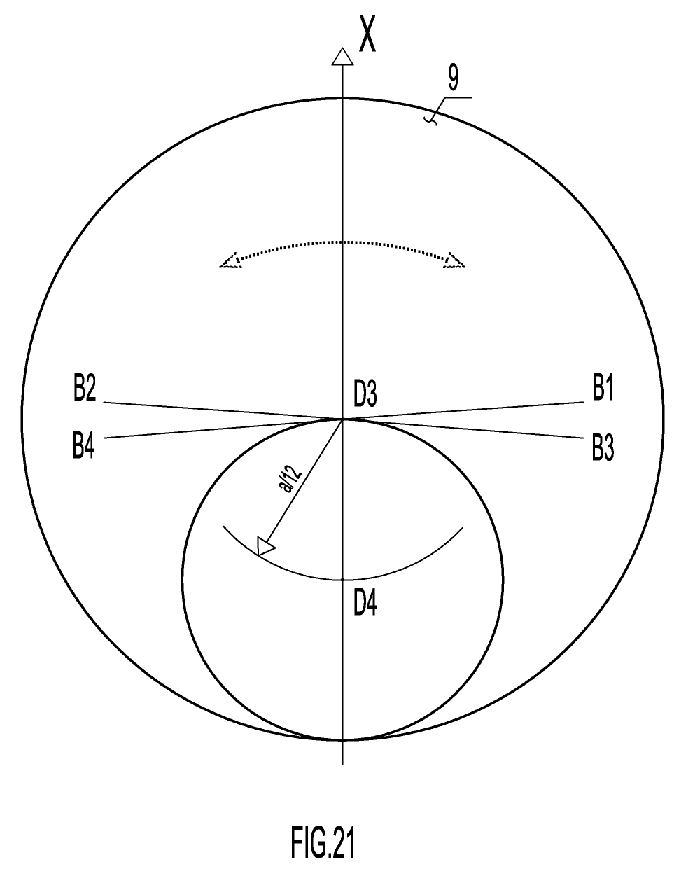

FIG. 21—The point (B3) is the final point of 90° rotational diagram. The points (B3) and (B2) is the diagram of second 90° rotation. Point (B4) is the final point of 270° rotational diagram. The points (B4) and (B1) is on the other hand the fourth 90° rotational diagram. The intersection of (B3) and (B2) diagram with (B4) and (B1) diagram is point (D3) on the (x) axis. The circle the radius of which is (r=a/12) drawn at this point intersects (x) axis at point (D4) and since this point is at equal distances to both diagrams, it is at the some time the center at shuttle element(9). The shuttle element(9) at this center can move at both direction.

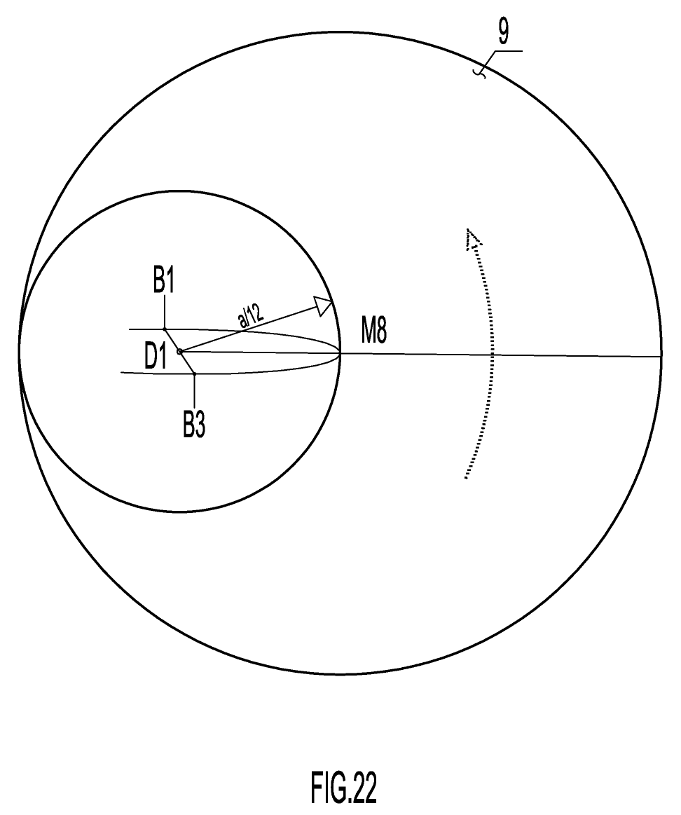

FIG. 22—The point (B1) is the starting point of rotational diagram. The points (B1) and (B3) is the diagram of 90° rotation. The center of shuttle element(9) must be at equal distances to (B1) and to (B3) which are the starting end final points of 90° diagram respectively. The path of eccentric center of shuttle element(9) is a diagram, the radius of circle which is tangent at (D2) is eccentric slipping distance of shuttle element(9) this distance is (r=a/12). The position of shuttle element(9) in the axis (D1) and (M8) is the final point of clock-wise rotation the center of which is (D1). This is also the starting point of counter clock-wise rotation.

The recognizing of borders of spin-off movement and the center of radius;

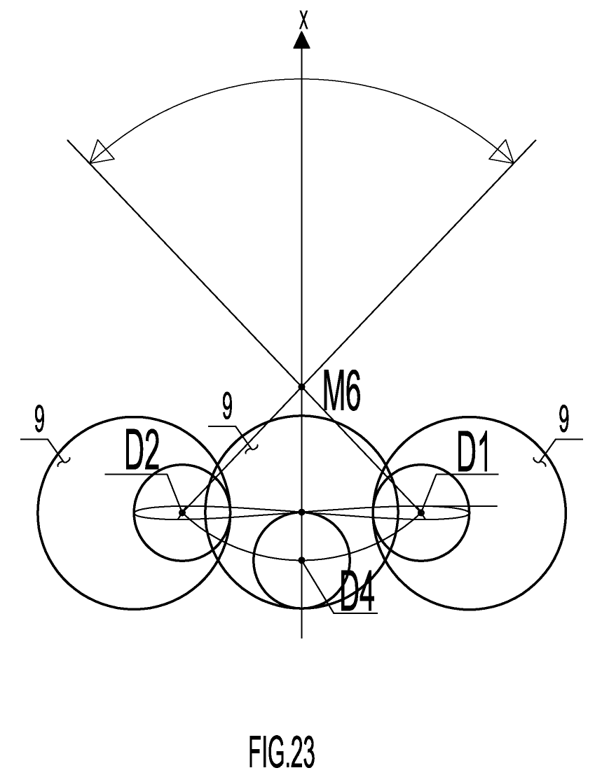

FIG. 23—The centers of shuttle element(9) are (D1), (D2) and (D4). The center of radius which passes through these points is (M6) on (x) axis the line between (D1) and (M6) is the limit of counter clock-wise rotation. The line between (D2) and (M6) is the limit of clock-wise rotation oscillation movement occurs in between these two lines.

Investigation of comparison of angular position of oscillation points of hammer element(2) and the action at disk element(10) at these positions according to rotational angle of eccentric element(3);

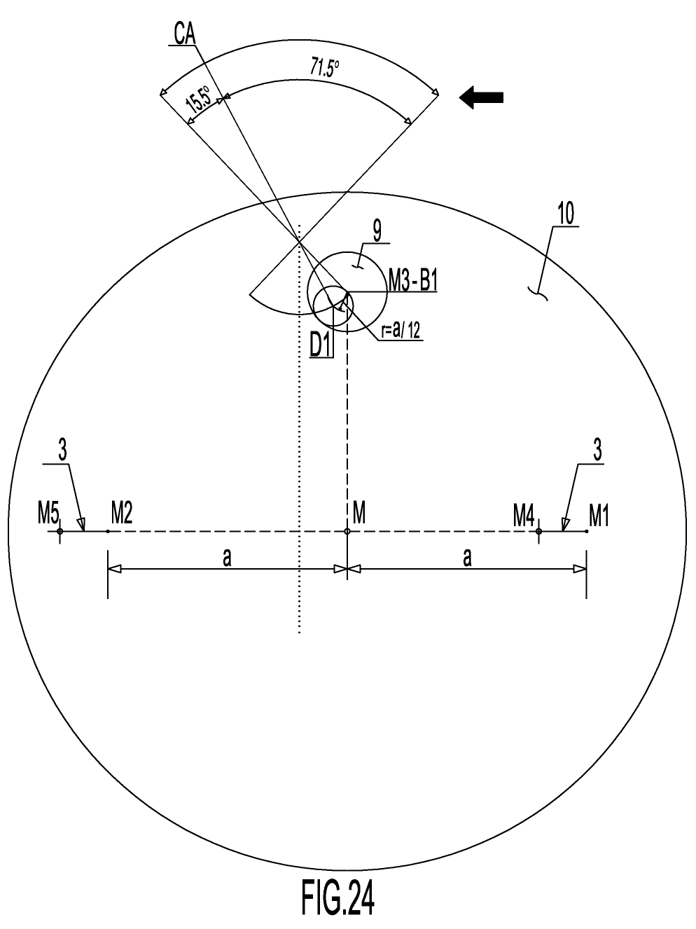

FIG. 24—When the angle of eccentric element(3) the centers of which are (M4) and (M5) are zero (M,M1=a) and (M,M2=a) and (M3) center of disc element(10) coincides with (B1). Point (D) which is the intersection point of the circle (r=a/12) the center of which is (B1) and the rotational period arc is the center of shuttle element(9). The line between point (D) and (M6) is the hammer axis line(CA). This line(CA) makes a 15.5° angle with the end oscillation line in counter clock-wise direction.

The explanation of the opposite force created at the first turning point;

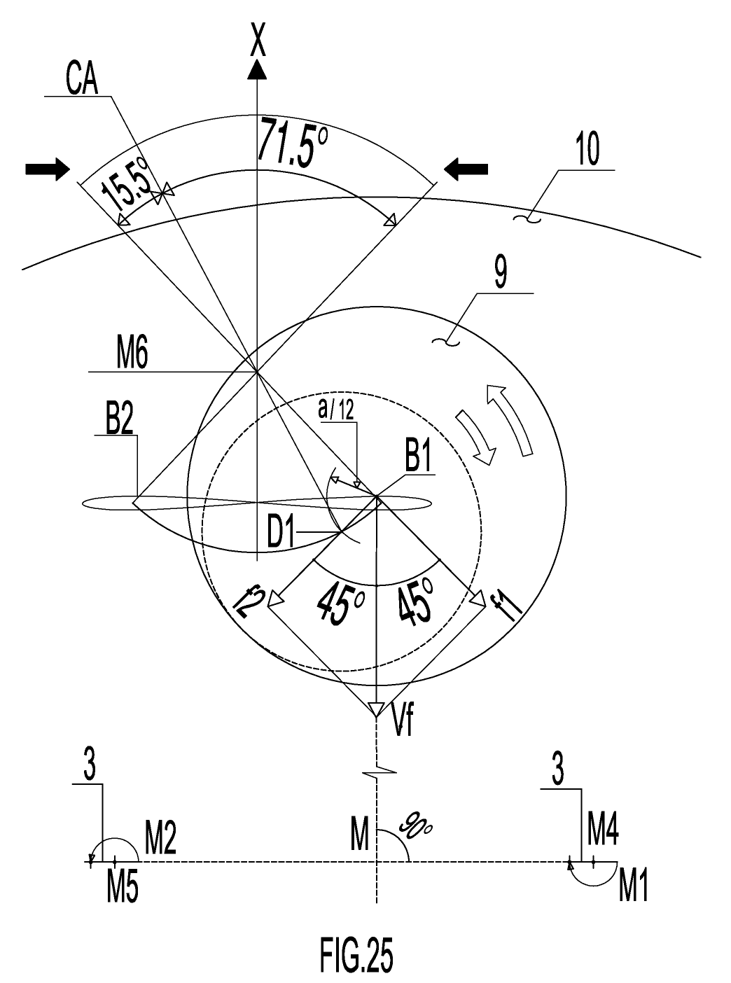

FIG. 25—Point (D1) which is the intersection of circle (r=a/12) the center of which is (B1) and the arc of oscillation period is the center of shuttle element(9). The line between (D1) and (M6) is the hammer axis line(CA). At this position line (CA) makes an angle of 15.5° to counter clock-wise oscillation period which is the first turning point of shuttle element(9) and this is the last position of it which fits to linear forces at both direction which is applied to (CA). The combined force (vf) of (f1) and (f2) which is applied on disc element(10) from the eccentric center of shuttle element(9) is perpendicular to (M1-M2) axis of disc element(10). The disc element(10) is accelerated with the pressure of combined force (vf) and the perpendicular angle turns out to wide angle. In this transformation the center of rotation of disc element(10) becomes the same as that of shuttle element(9) and makes it rotate in clock-wise direction. When the shuttle element(9) is achieving this action it is transformed to a leverage where eccentric center (B1) is sliding support and rotation center is load end. The opposite force created by this leverage is directly proportional with the pressure force and makes it complete 15.5° rotational motion of hammer axis(CA) in counter clock-wise direction. The motion of the disc element(10) depends on the motion of eccentric element(3). The clock-wise rotation of the eccentric element(3) the center of which is (M4) and the counter clock-wise rotation of eccentric element(3) the center of which is (M5) makes the rotation of disc element(10) with two-centered rotation possible. During the rotation of disc element(10) starting from (B1), the distance (M,M1) is fixed and the slipping distance is (M,M2). Slipping keeps on going until 180° rotation of eccentric elements(3) in reverse direction is completed.

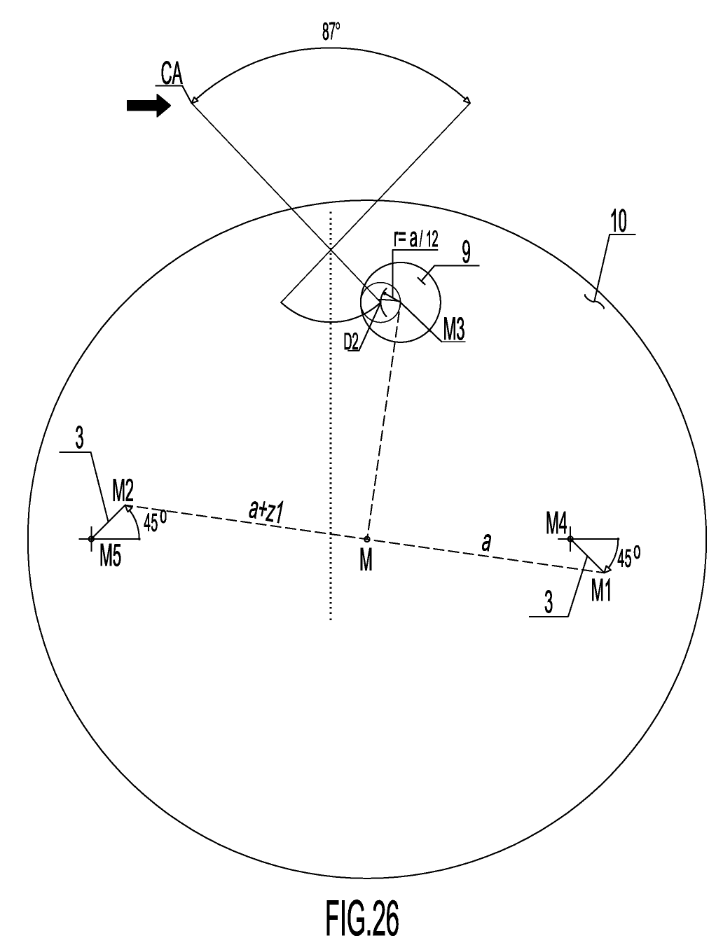

FIG. 26—When the eccentric elements(3) with (M4) and (M5) centers makes 45° angle with x-axis; (M,M1)=(a), (M,M2)=(a+z1) and the point (D2) which is the inter section point circle (r=a/12) with (M3) center and arc of oscillation period is the center of shuttle element(9). The distance between (a) and (M6) is (CA). At this position (CA) coincides whit oscillation period.

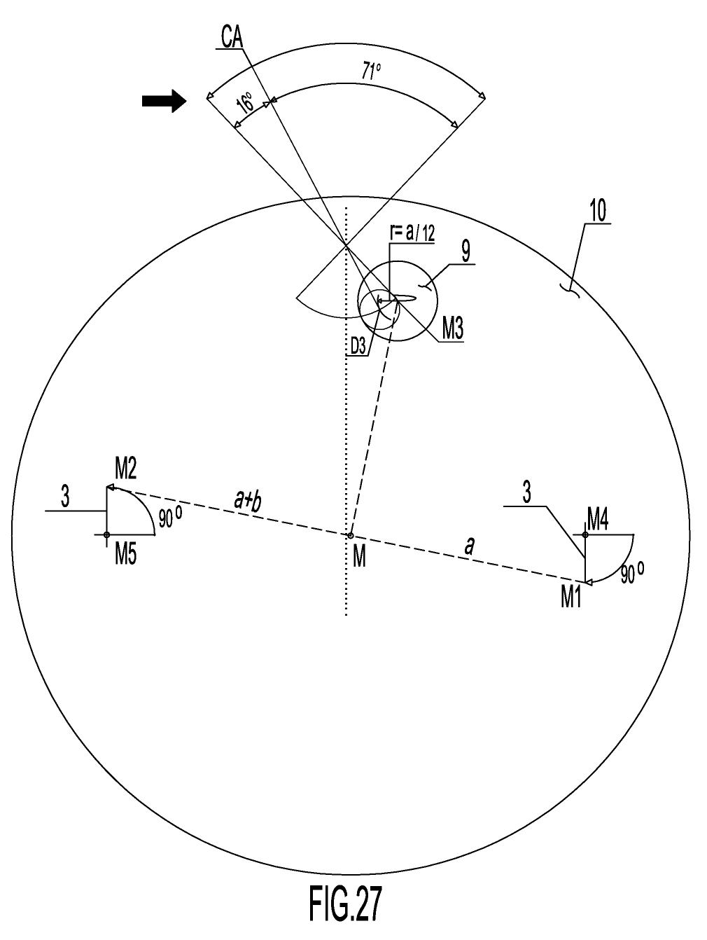

FIG. 27—when eccentric elements(3) with (M4) and (M5) centers makers an angle 90° with x-axis; (M,M1)=(a) and (M,M2)=(a+b) and the intersection point (D3) of (r=a/12) circle the center of which is (M3) of disc element(10) and of arc of oscillation period is the center of shuttle element (9). The line between the point(9) and (M6) is (CA). (CA) is 16° away from end oscillation line in clock-wise direction.

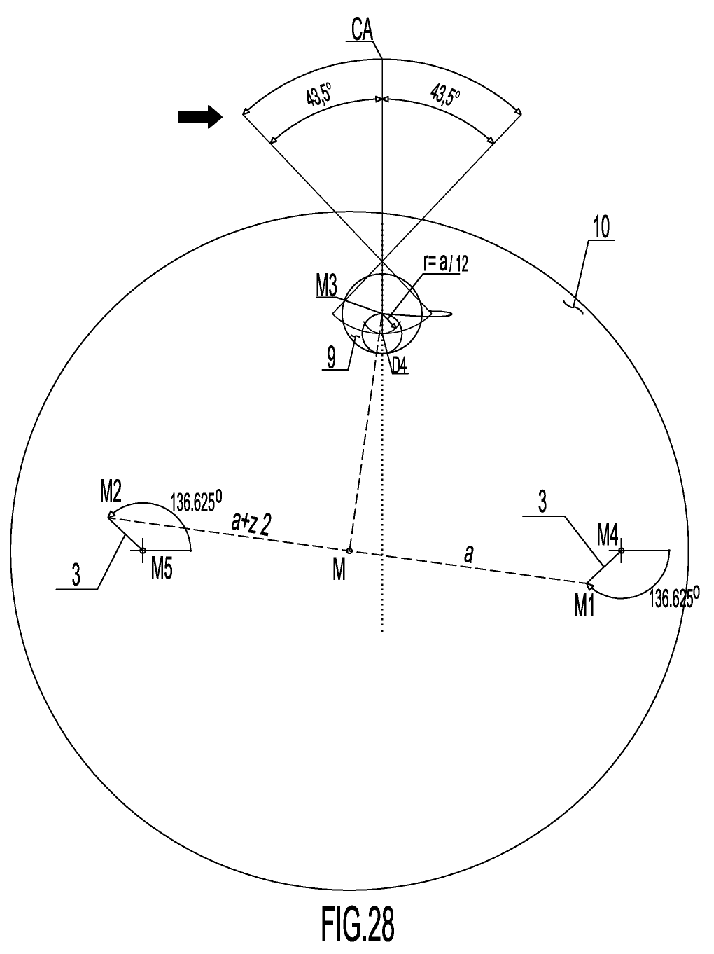

FIG. 28—When eccentric elements(3) with centers (M4) and (M5) makes 136.625° angle with x-axis (horizontal), (M,M1)=(a), (M,M2)=(a+z2) and the inter section point(D4) of r=(a/12) circle with center (M3) of disc element(10) with the arc of oscillation period is the center of shuttle element (a). The line between (9) and M6 is (CA). (CA) is the midpoint at the oscillation period. Ever though eccentric elements(3) rotates 136.625°, both ends oscillation lines are at 43.5° angle.

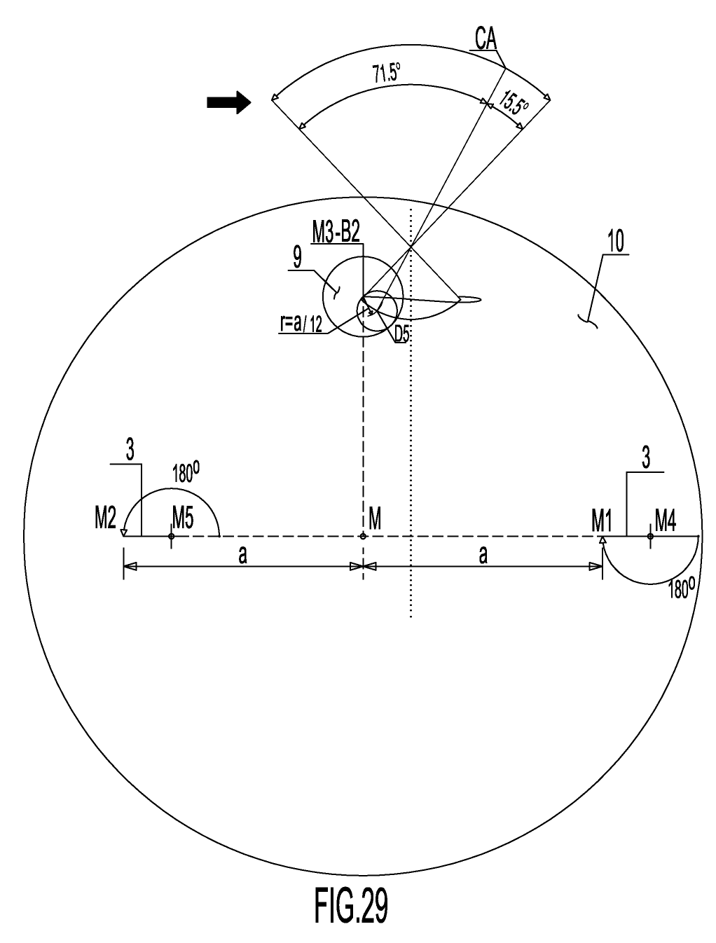

FIG. 29—When eccentric elements(3) with (M4) and (M5) center rotates 180° they coincides with y-axis and (M,M1)=(M,M2)=(a) and (M3) of disc element(10) coincides with (B2). This point (B2) is the starting point of the diagram of (M3) of disc element(10) the circle r=(a/12) drawn from this point inter sects arc of oscillation period at (D5) and it is the center of shuttle element(9). The line between (9) end (M6) is (CA). (CA) makes an angle of 15.5° with the line of end oscillation line of oscillation period in clock-wise direction.

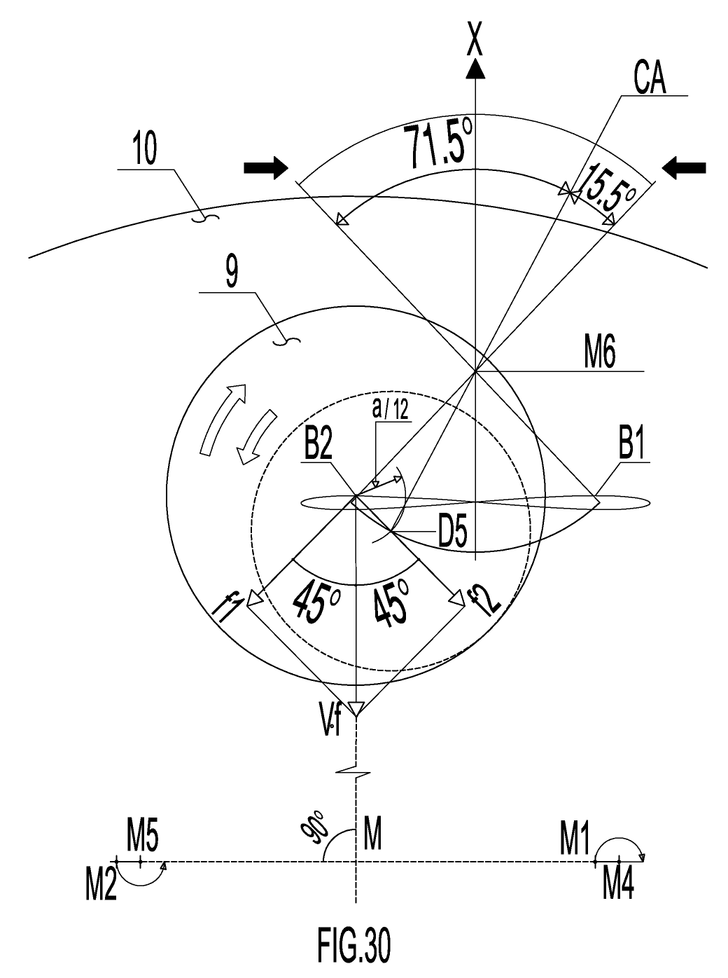

The explanation of the opposite force created at the second turning point; FIG. 30—Point (D5) which is the intersection of circle (r=a/12) the center of which is (B2) and the arc of oscillation period is the center of shuttle element(9). The line between (D5) and (M6) is the hammer axis line(CA). At this position line (CA) makes an angle of 15.5° to counter clock-wise oscillation period which is the second turning point of shuttle element(9) and this is the last position of it which fits to linear forces at both direction which is applied to (CA). The combined force (vf) of (f1) and (f2) which is applied on disc element(10) from the eccentric center of shuttle element(9) is perpendicular to (M1-M2) axis of disc element(10). The disc element (10) is accelerated with the pressure of combined force (vf) and the perpendicular angle turns out to wide angle. In this transformation the center of rotation of disc element(10) becomes the same as that of shuttle element(9) and makes it rotate in counter clock-wise direction. When the shuttle element(9) is acchieving this action it is transformed to a leverage where eccentric center (B2) is sliding support and rotation center is load end. The opposite force created by this leverage is directly proportional with the pressure force and makes it complete 15.5° rotational motion of hammer axis (CA) in clock-wise direction.

The motion of the disc element(10) depends on the motion of eccentric element(3). The clock-wise rotation of the eccentric element(3) the center of which is (M4) and the counter clock-wise rotation of eccentric element(3) the center of which is (M5) makes the rotation of disc element(10) with two-centered rotation possible. During the rotation of disc element(10) starting from (B2), the distance (M,M2) is fixed and the slipping distance is (M,M1). Slipping keeps on going until 180° rotation of eccentric elements(3) in reverse direction is completed.

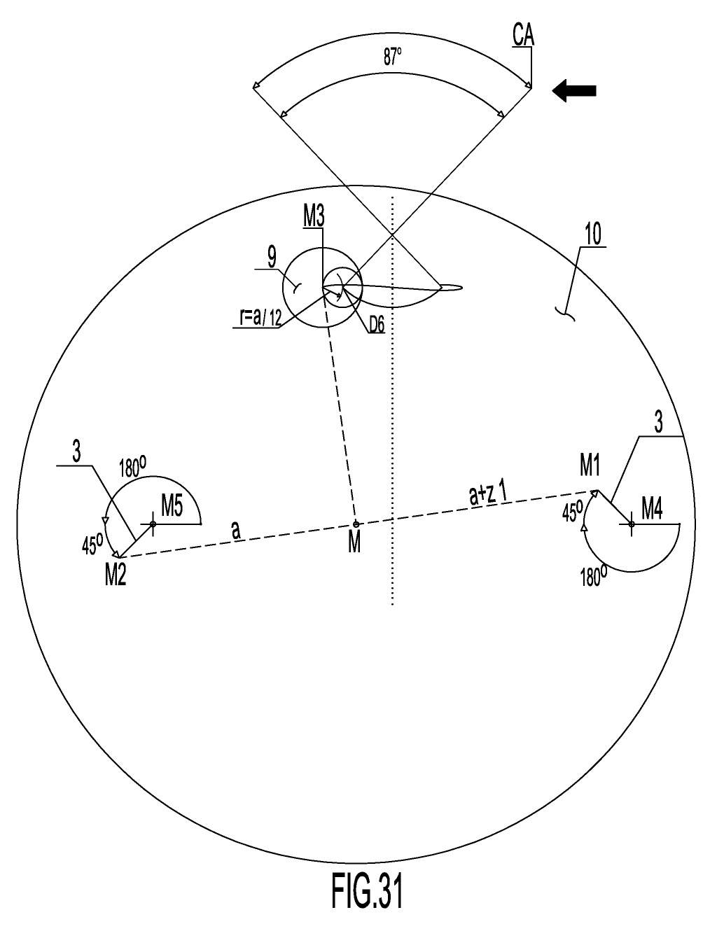

FIG. 31—When the eccentric axles(3) with (M4) and (M5) centers make or angle (180°+45°); if (M,M1)=(a+z1) then (M,M2)=(a) and the intersection (D6) of the circle (r=a12) the center of which is (M3) and the oscillation period arc is the center of shuttle element(9). The line(CA) which connects point(9) and (M6) is the hammer axle. At this position hammer axle line(CA) coincides with oscillation period.

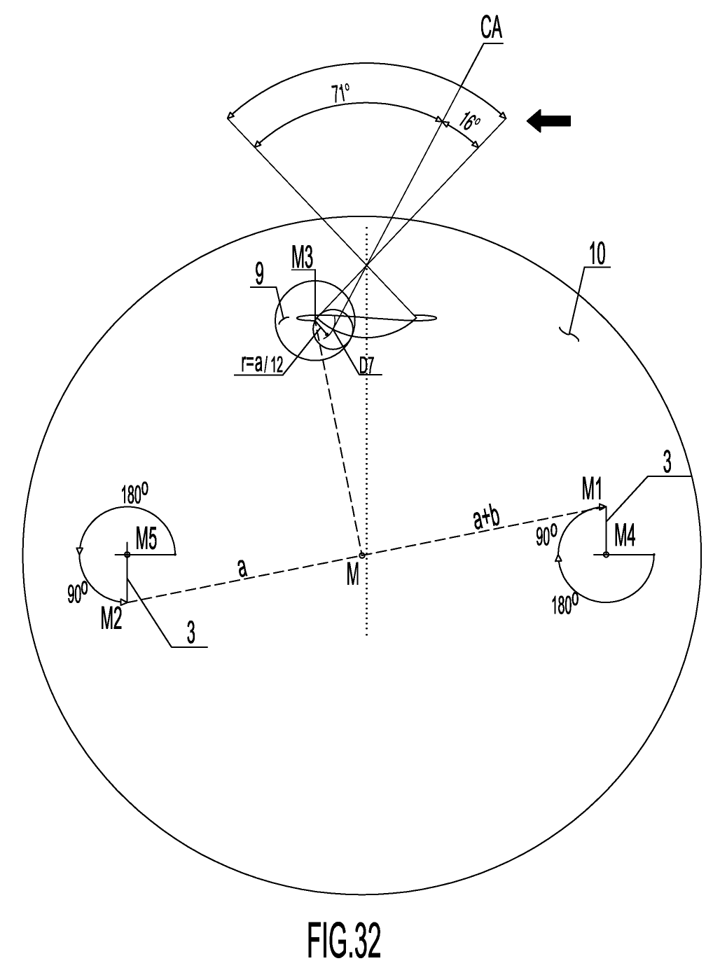

FIG. 32—When the eccentric axles(3) with (M4) and (M5) centers make or angle (180°+90°); if (M,M1)=(a+b) then (M,M2)=(a) and the intersection (D7) of the circle (r=a12) the center of which is (M3) and the oscillation period arc is the center of shuttle element(9). The line(CA) which connects point(9) and (M6) is the hammer axle. The angle of this line with oscillation period is 16° counter clock-wise.

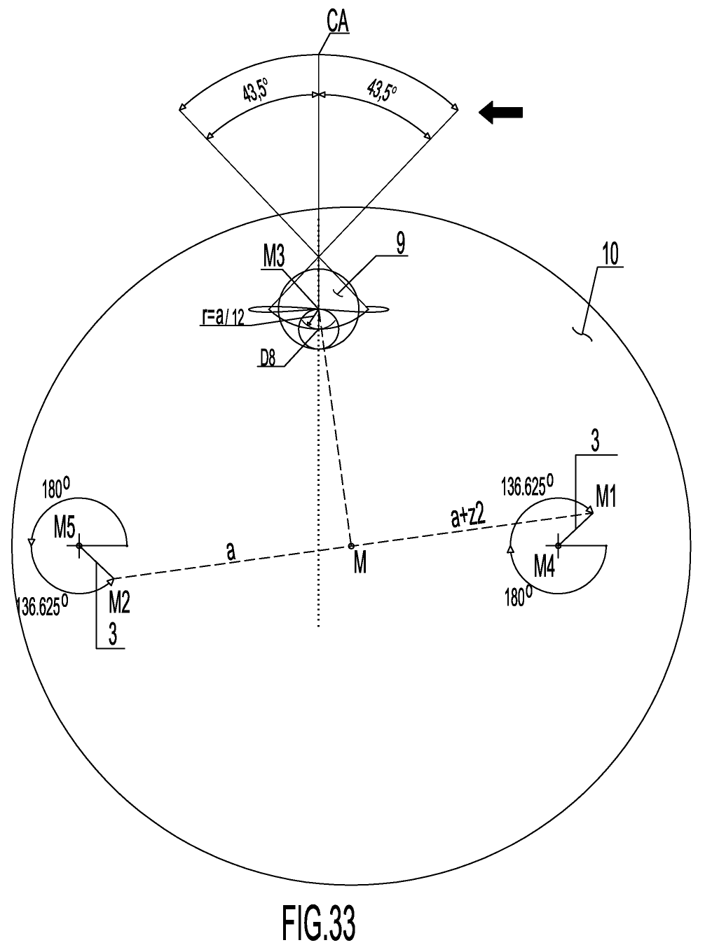

FIG. 33—When the eccentric axles(3) with (M4) and (M5) centers make or angle (180°+136.625°); if (M,M1)=(a+z2) then (M,M2)=(a) and the intersection (D8) of the circle (r=a12) the center of which is (M3) and the oscillation period arc is the center of shuttle element(9). The line(CA) which connects point(9) and (M6) is the hammer axle. The line (CA) is the midpoint of oscillation period. Even though the eccentric elements(3) rotates 136.625° they make 43.5° angle with both oscillation lines.

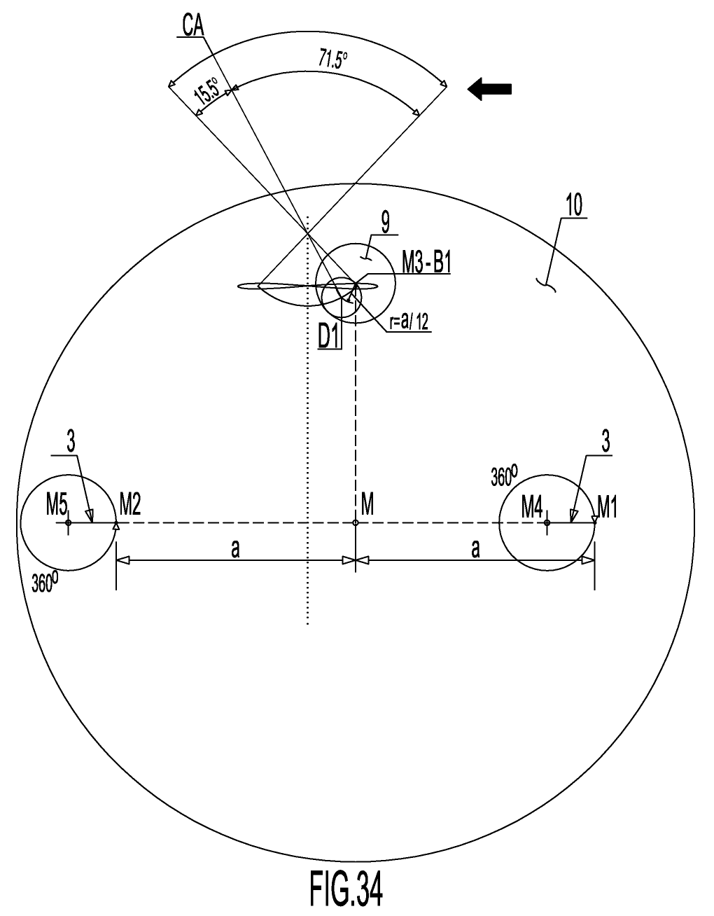

FIG. 34—When the eccentric axles(3) with (M4) and (M5) centers complete (180°+180°) degree rotation in opposite direction, they coincides with (y) axis. At this stage (M,M1)=(a) and (M,M2)=(a) and (M3) center of disc element(10) coincides with point (B1). The point (D1) which is the intersection of the circle the center of which is (B1) and oscillation period arc is the center of shuttle element(9). The line between (9) and (M6) is the hammer axle line(CA). (CA) makes a 15.5° angle with and oscillation line in counter clock-wise direction.

In order to get the purpose of invention figures are shown below as addition topics

FIG. 35—Schematic diagram of the apparatus elements according to their functional dimensions.

FIG. 36—The view of the auxiliary hammer element of apparatus connected to hammer element axle of the apparatus.

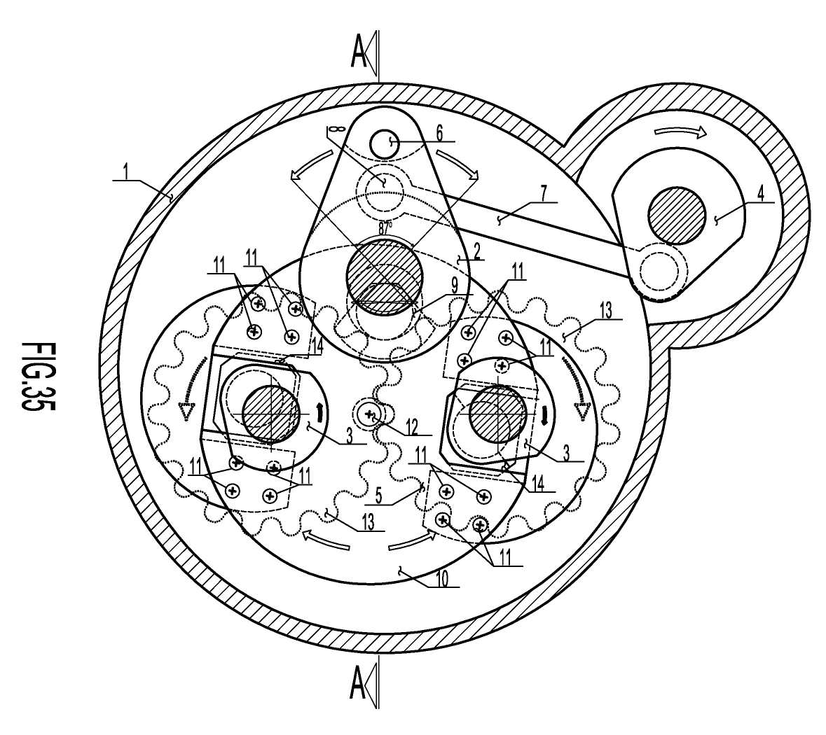

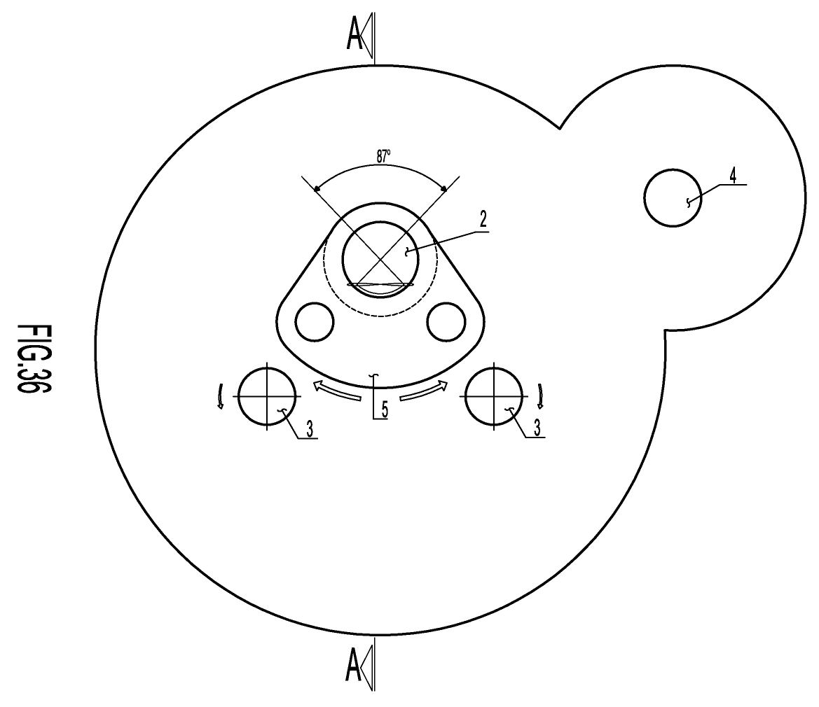

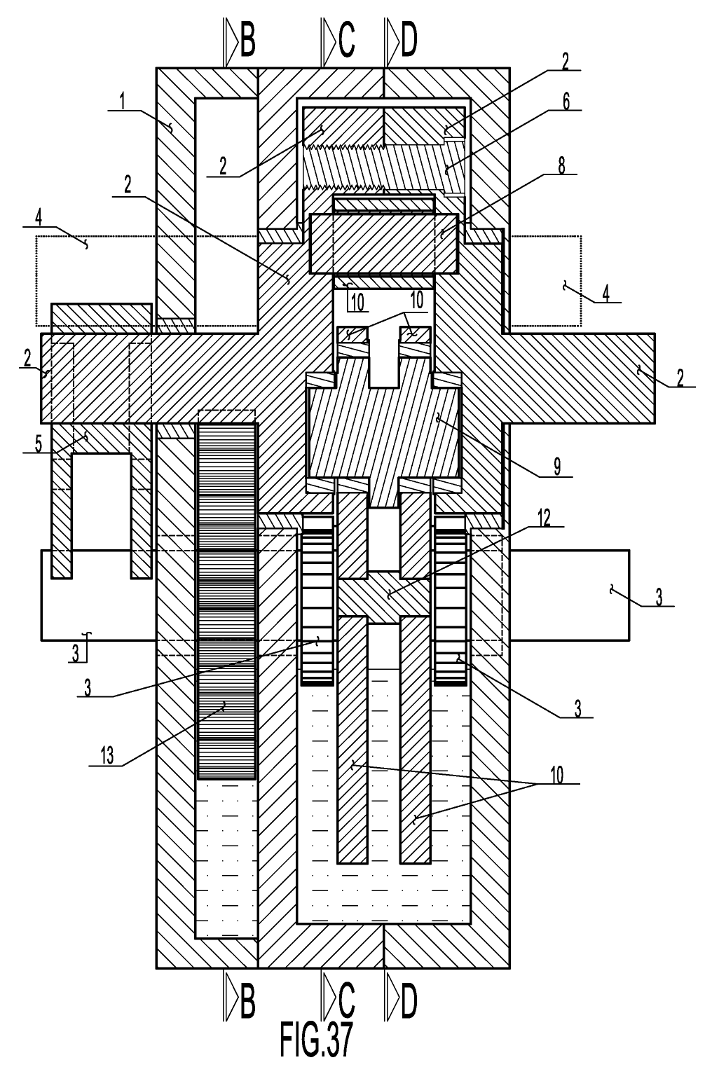

FIG. 37—Front view of (A-A) section of the apparatus.

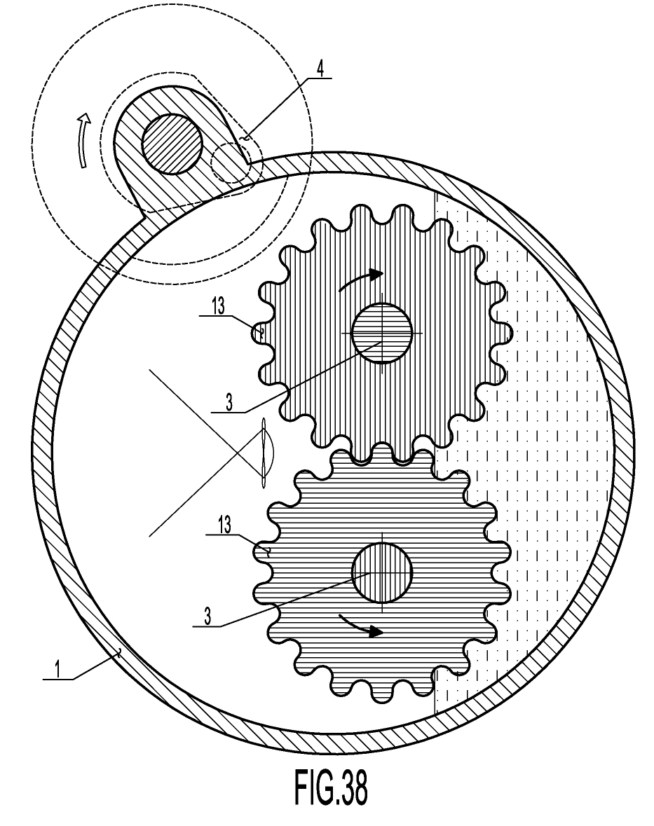

FIG. 38—Front view of (B-B) section of the apparatus.

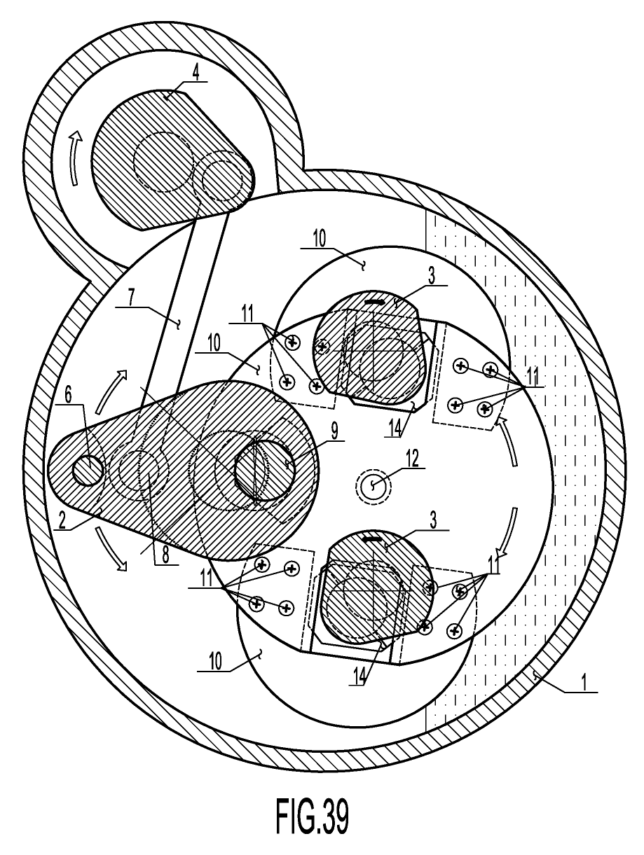

FIG. 39—Front view of (C-C) section of the apparatus.

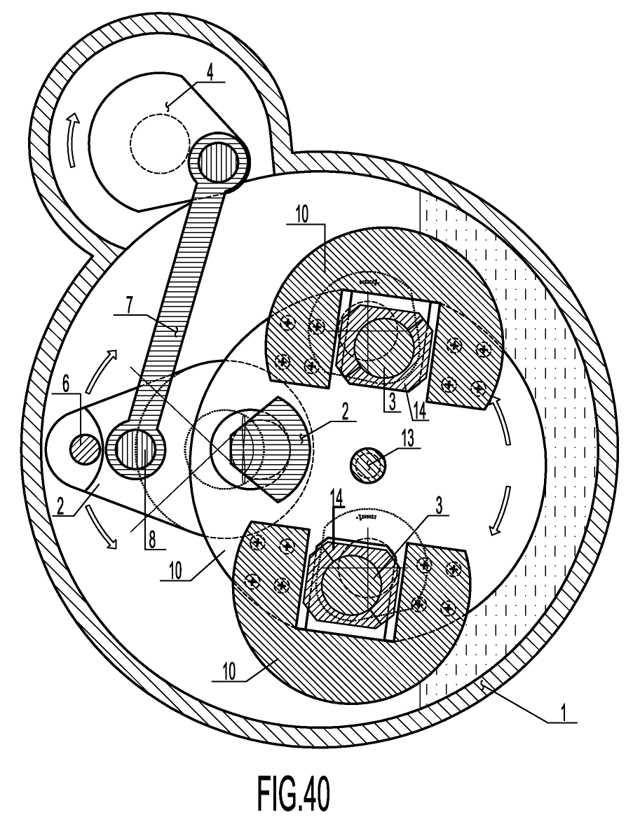

FIG. 40—Front view of (D-D) section of the apparatus.

FIG. 41—Section view of compressor of the apparatus.

FIG. 42—Front view of (E-E) section of power production apparatus from compressed gas by moment of inertia.

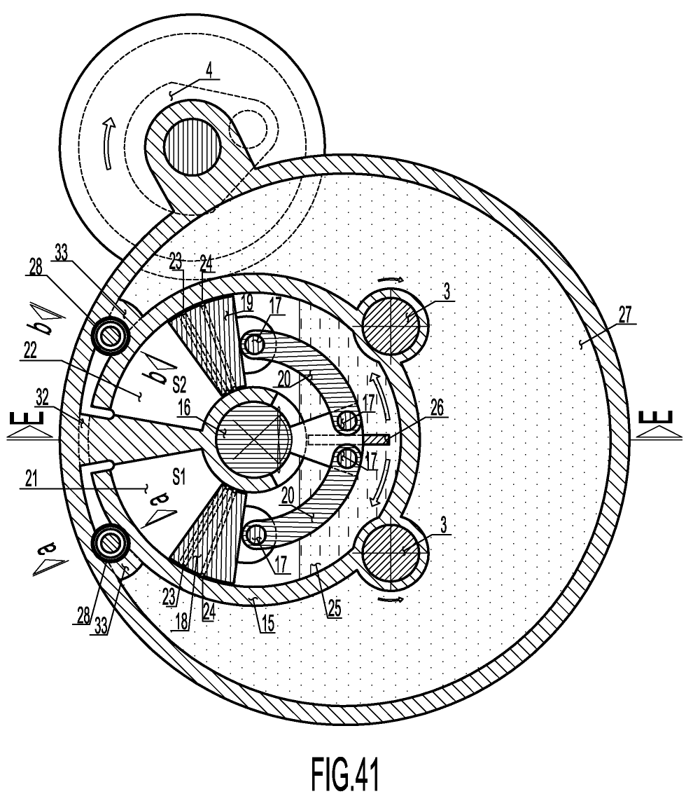

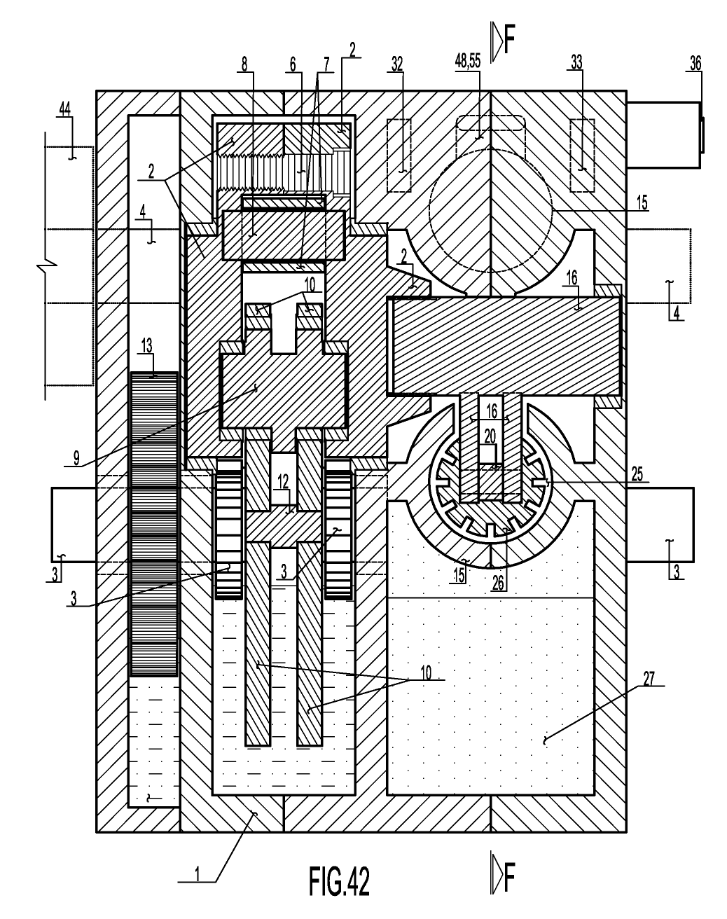

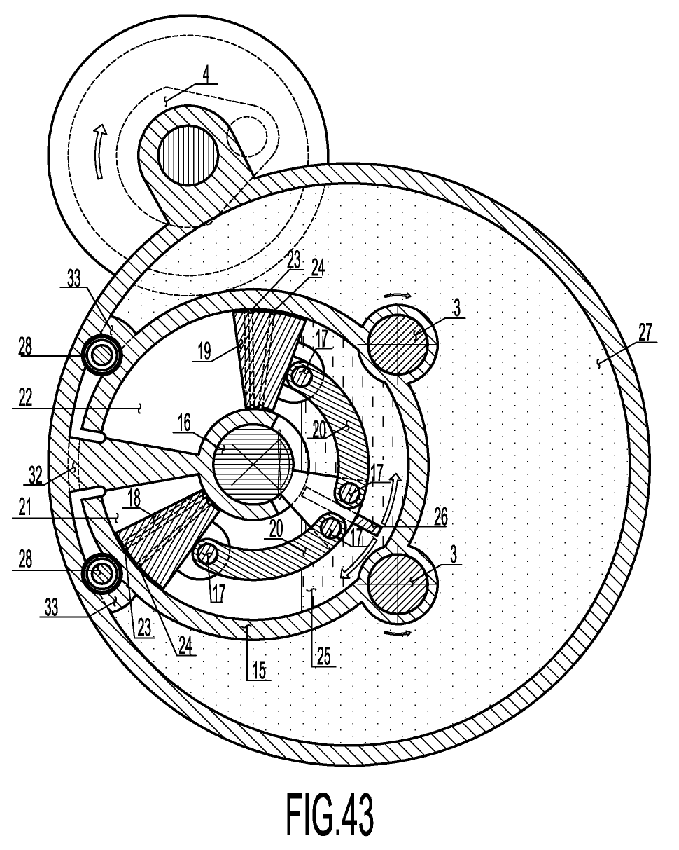

FIG. 43—Front view of (F-F) section of power production apparatus from compressed gas by moment of inertia when (P1) piston is 15.5° away from end oscillating angle or in a position of 71.5° clock-wise.

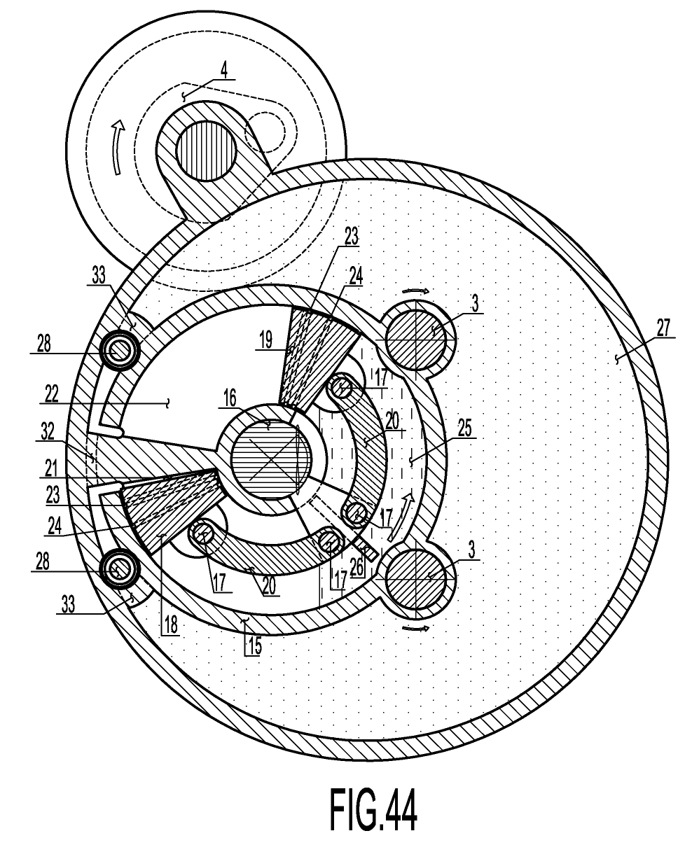

FIG. 44—Front view of (F-F) section of power production apparatus from compressed gas by moment of inertia when (P1) piston coincides with end oscillating angle.

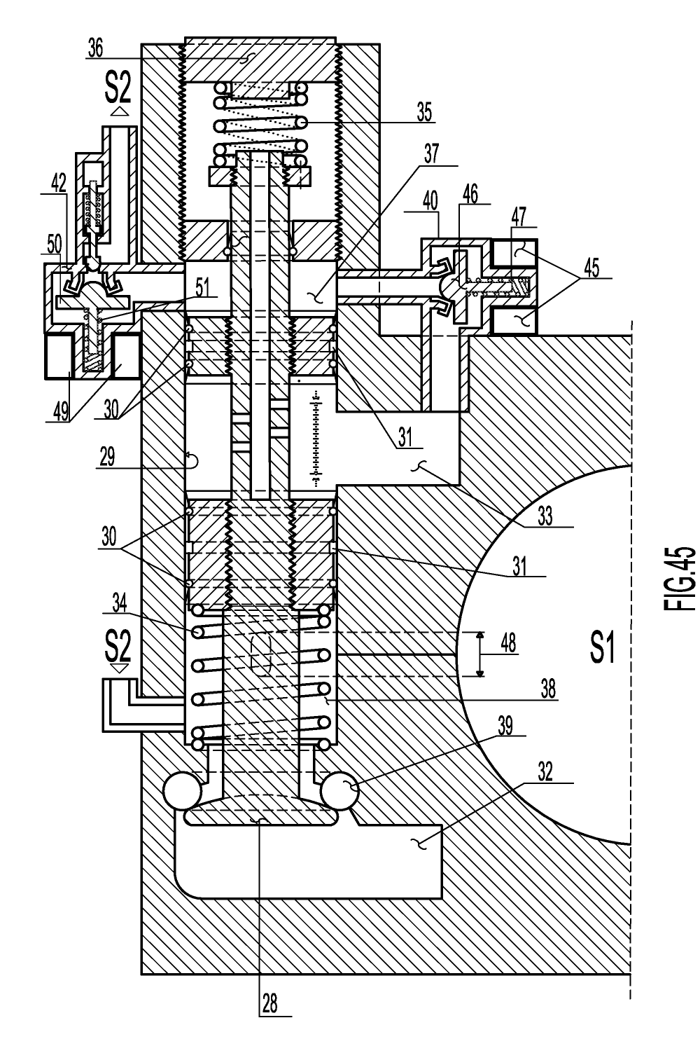

FIG. 45—(a-a) section of air shuttle when compressed air entrance duet is closed.

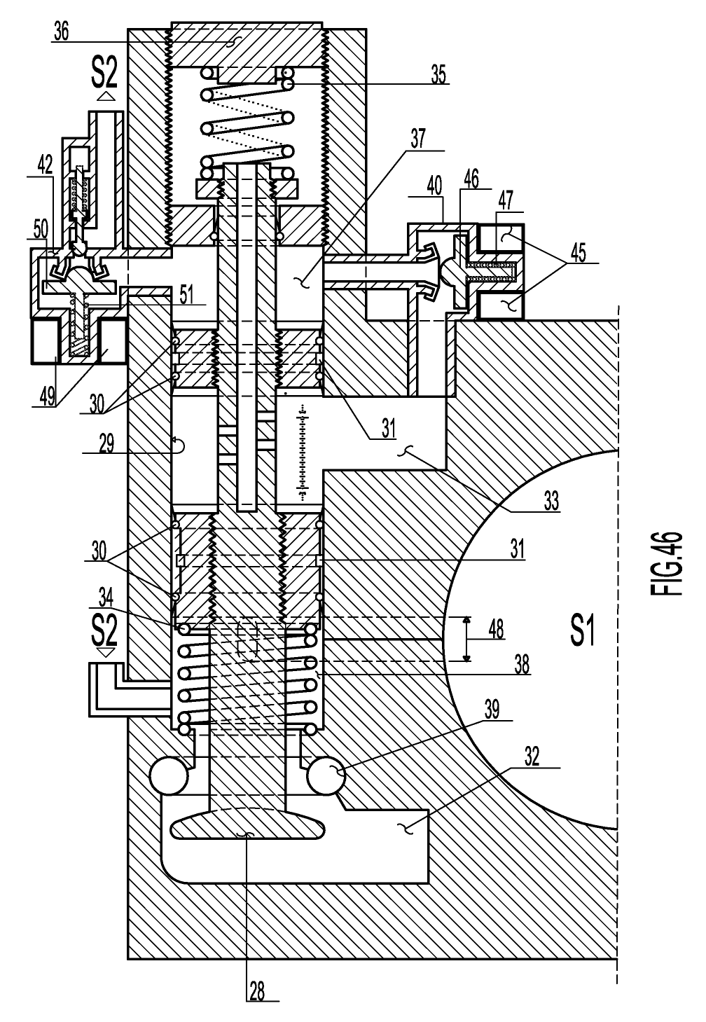

FIG. 46—(a-a) section of air shuttle when compressed air entrance duet is open.

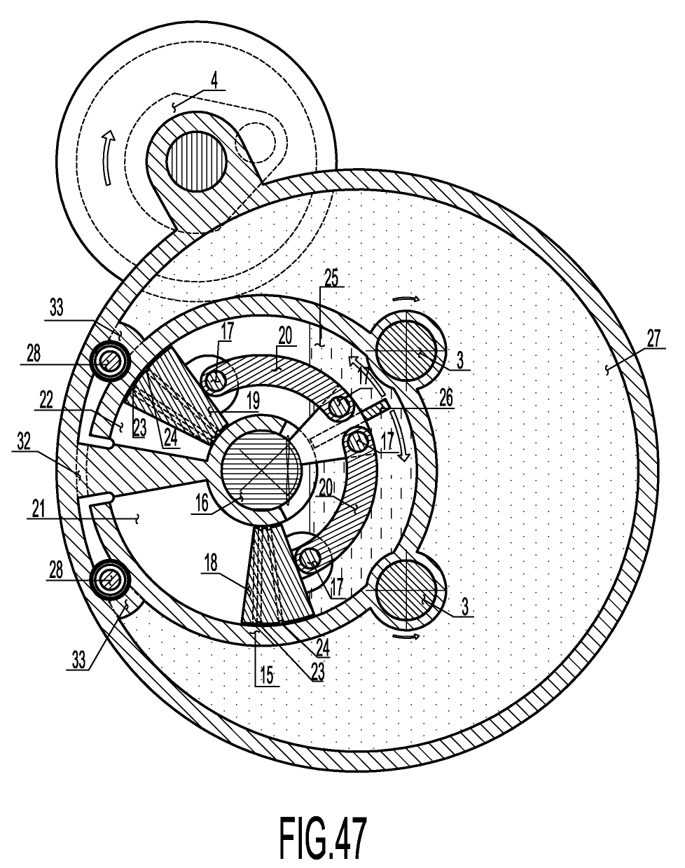

FIG. 47—Front view of (F-F) section of power production apparatus from compressed gas by moment of inertia when (P2) piston is 15.5° a way from and oscillating angle or in a position of 71.5° reverse clock-wise.

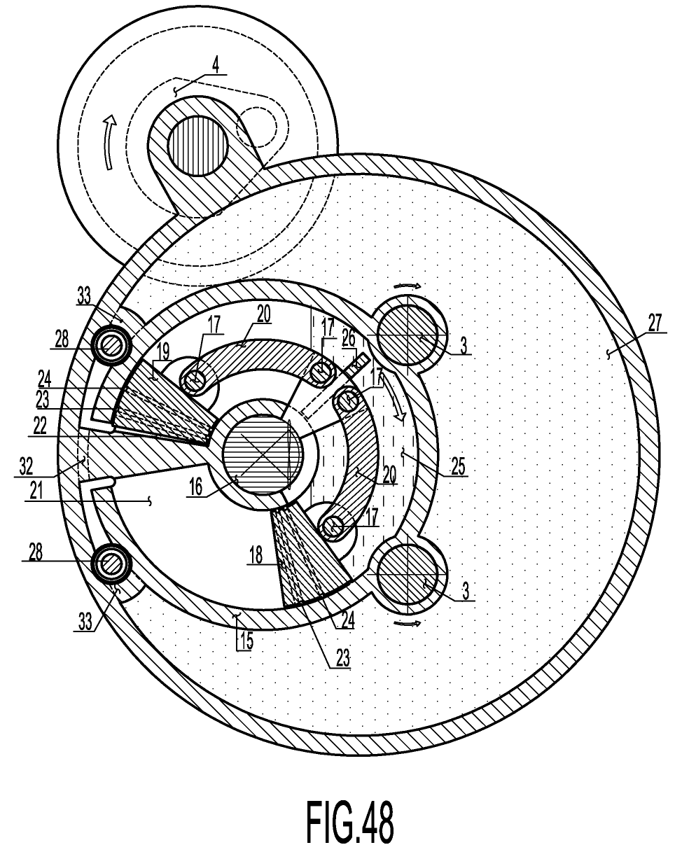

FIG. 48—Front view of (F-F) section of power production apparatus from compressed gas by moment of inertia when (P2) piston coincides with and oscillating angle.
8

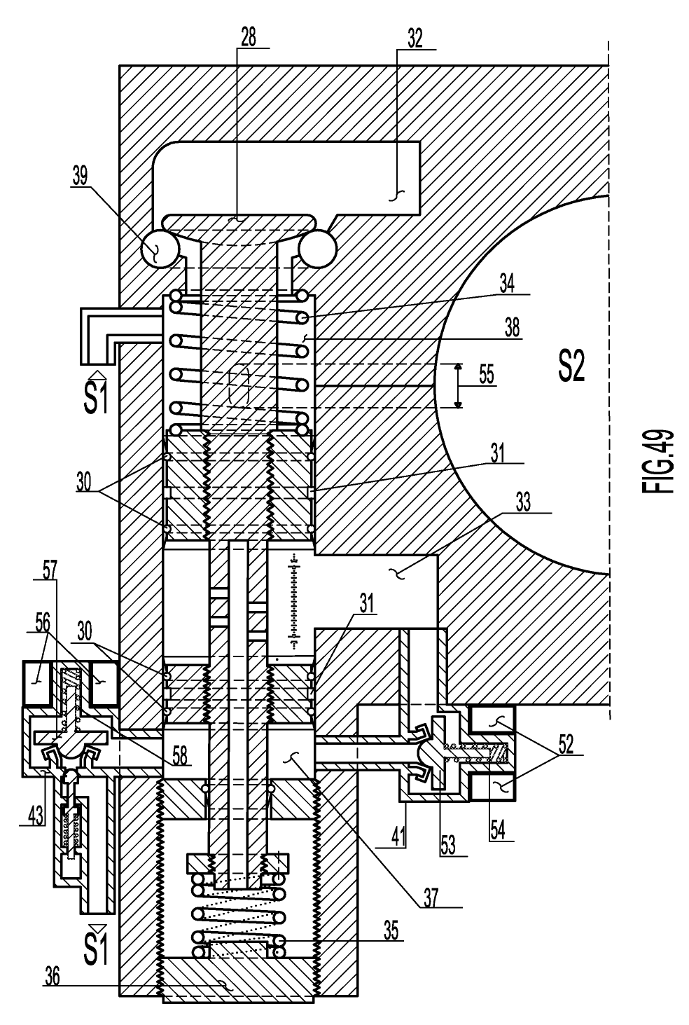

FIG. 49—(b-b) section of air shuttle when compressed air entrance duet is closed.

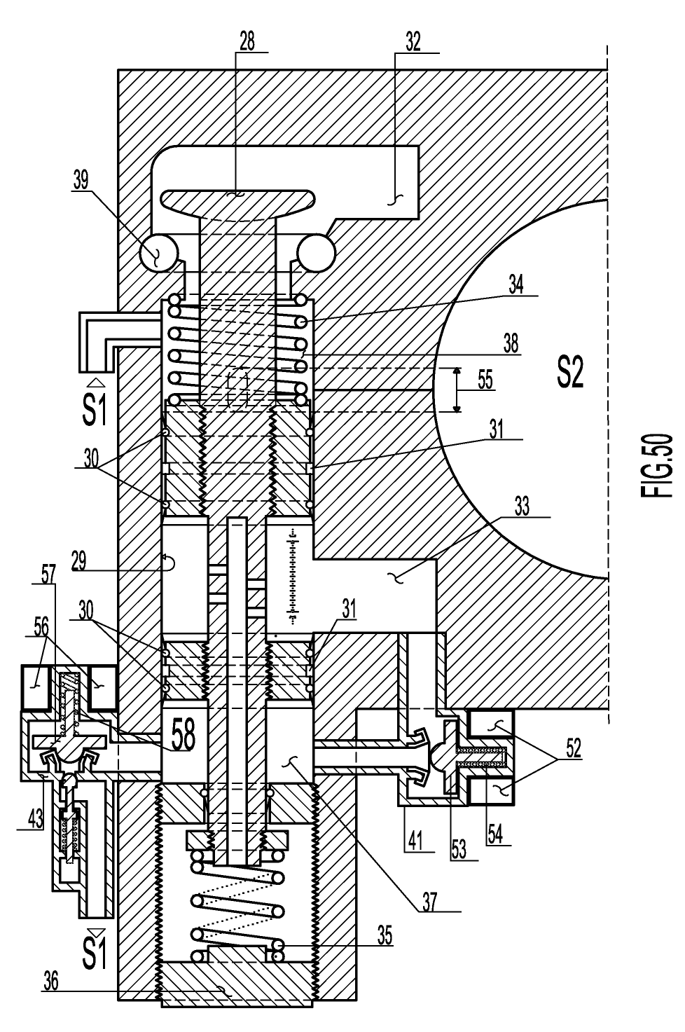

FIG. 50—(b-b) section of air shuttle when compressed air entrance duet is open.

FIG. 51—Front view of motor piston position 15.5° to end oscillating angle.

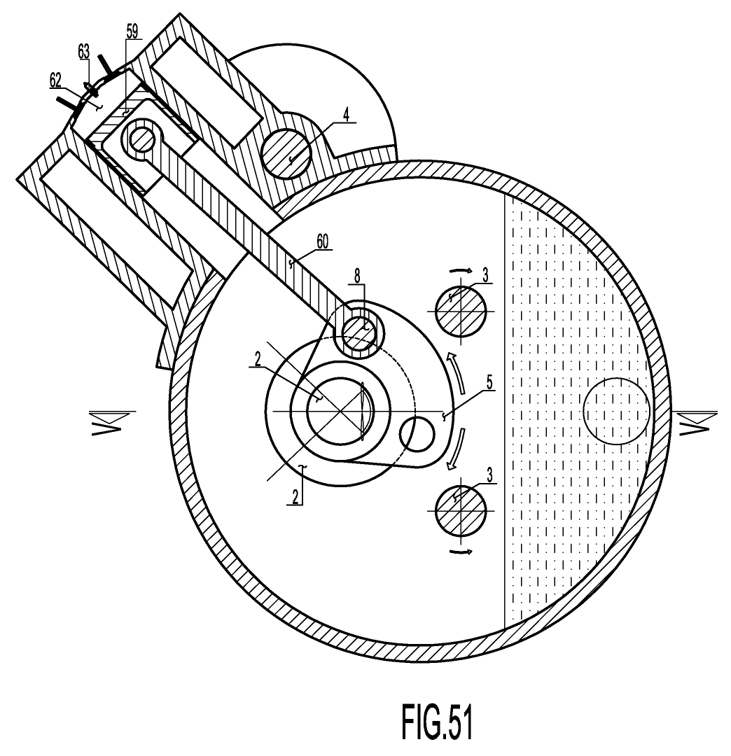

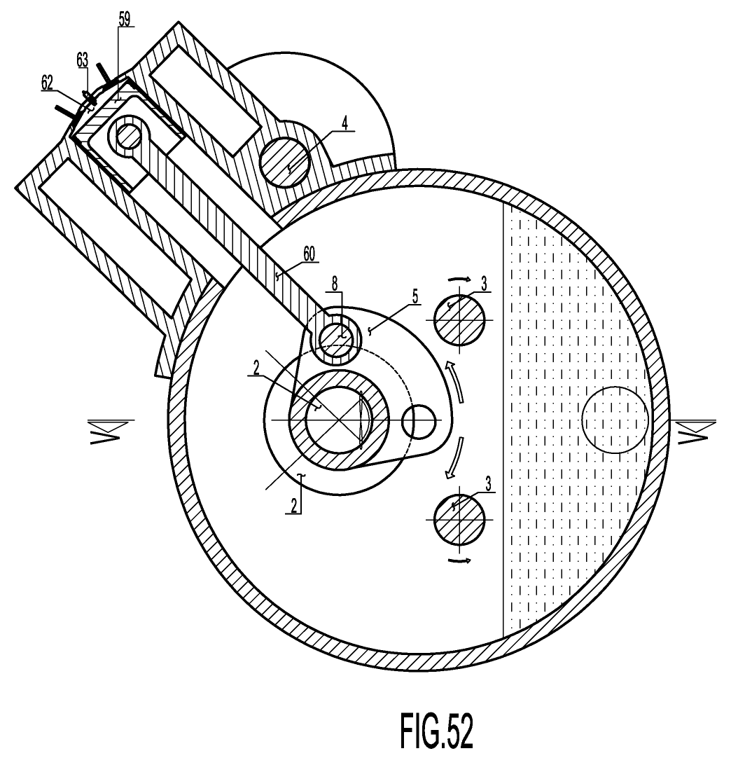

FIG. 52—Front view of motor piston position coinciding with end oscillating angle.

FIG. 53—(V-V) section of spontaneous combustion reciprocating engine.

FIG. 54—Front view of hammer element.

FIG. 55—(G-G) section of hammer element.

FIG. 56—Perspective view at hammer element.

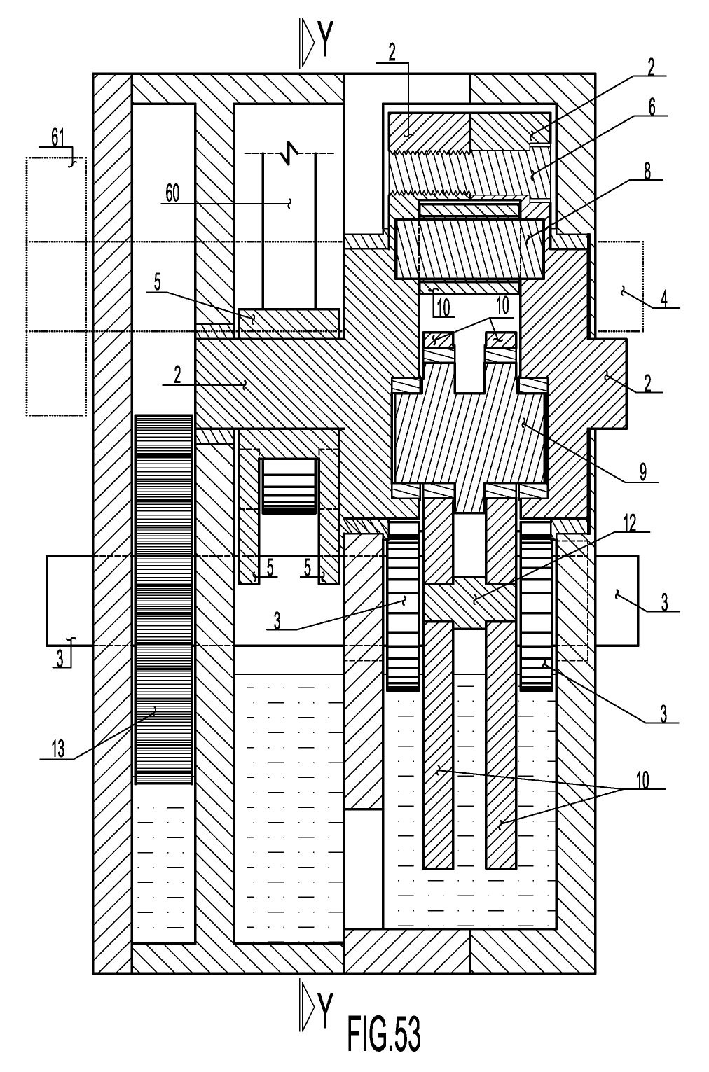

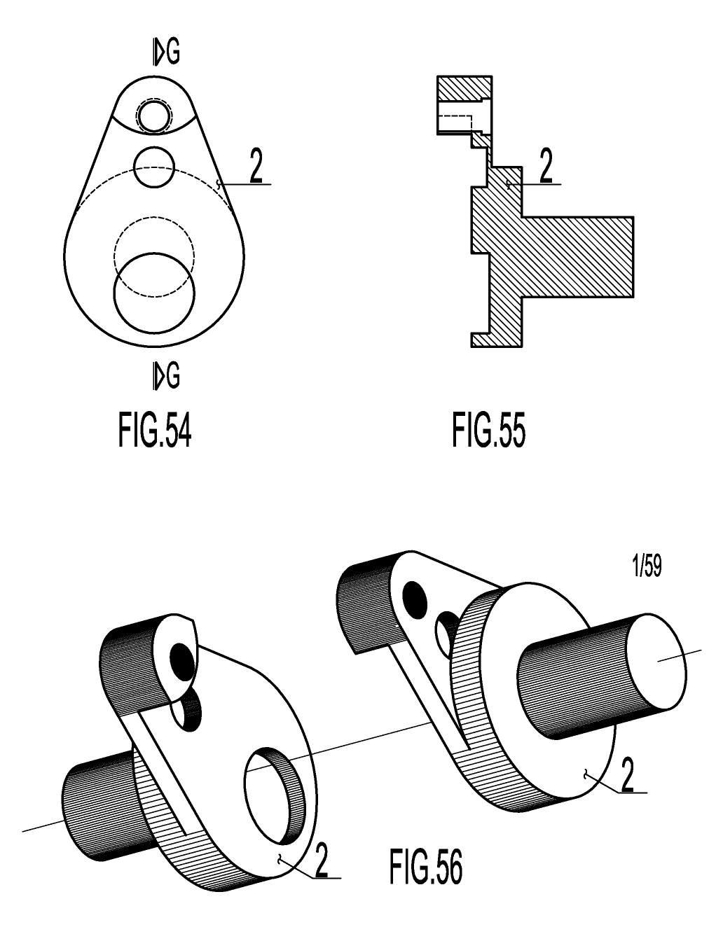

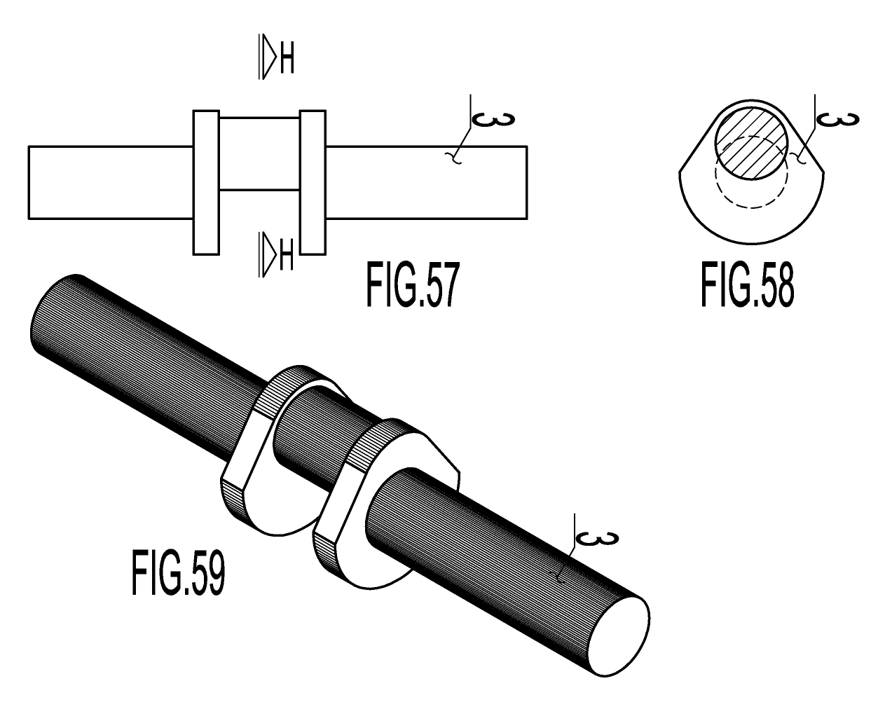

FIG. 57—Front view of eccentric element.

FIG. 58—(H-H) section of eccentric element.

FIG. 59—Perspective view at eccentric element.

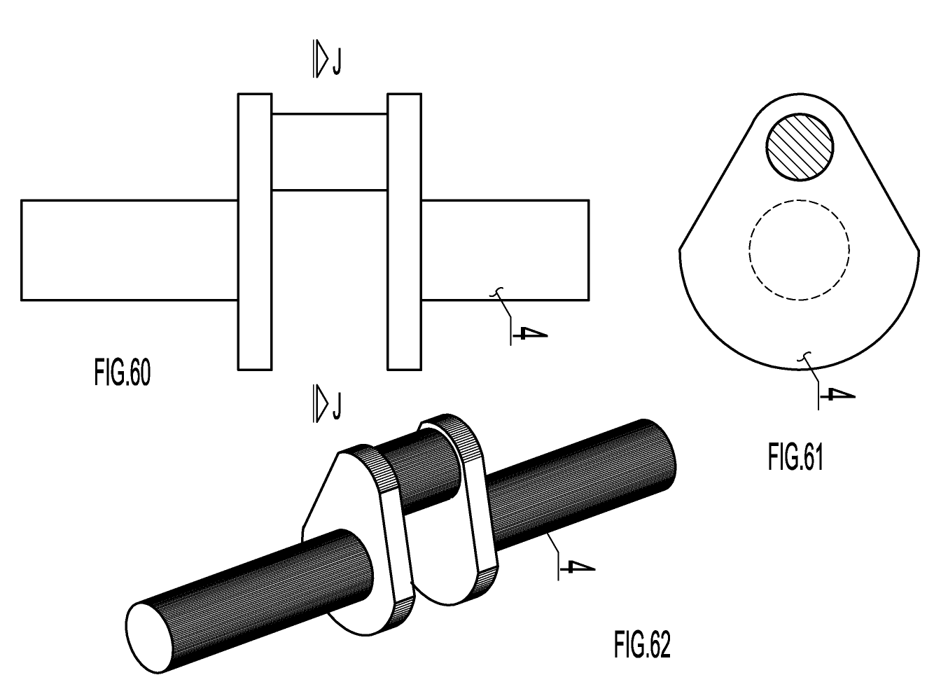

FIG. 60—General view of auxiliary eccentric element.

FIG. 61—(J-J) section of auxiliary eccentric element.

FIG. 62—Perspective view of auxiliary eccentric element.

FIG. 63—General view of auxiliary hammer element.

FIG. 64—(K-K) section of auxiliary hammer element.

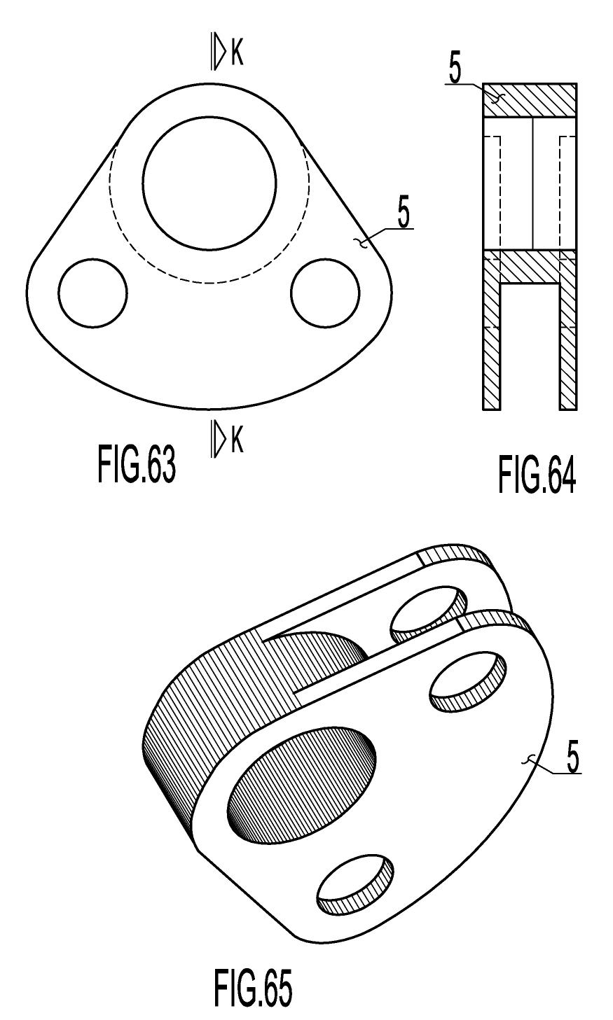

FIG. 65—Perspective view of auxiliary hammer element.

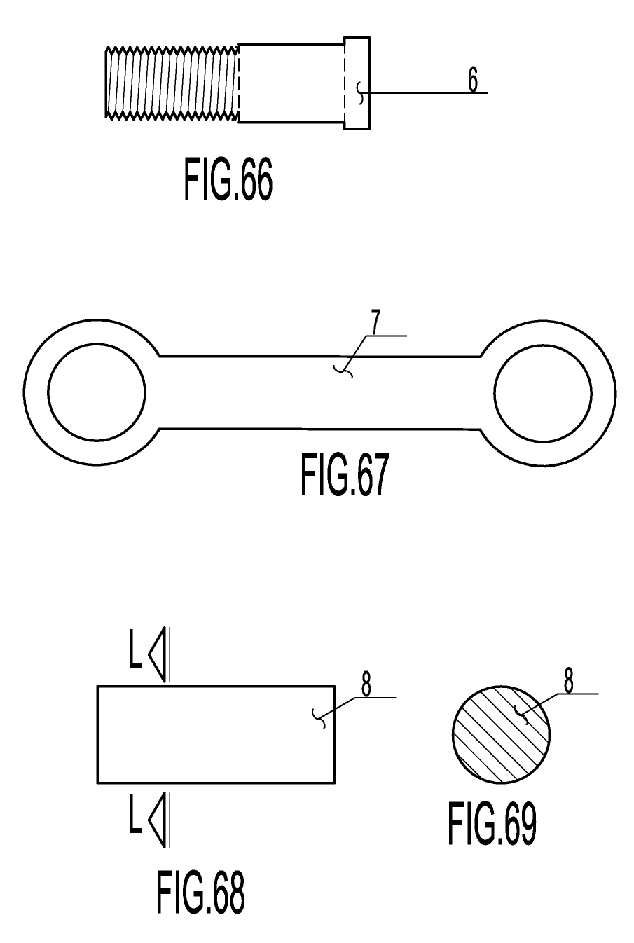

FIG. 66—General view of fixing screw elements.

FIG. 67—Plan view of intermediate arm element.

FIG. 68—Plan view of anchor pin.

FIG. 69—(L-L) section of anchor pin.

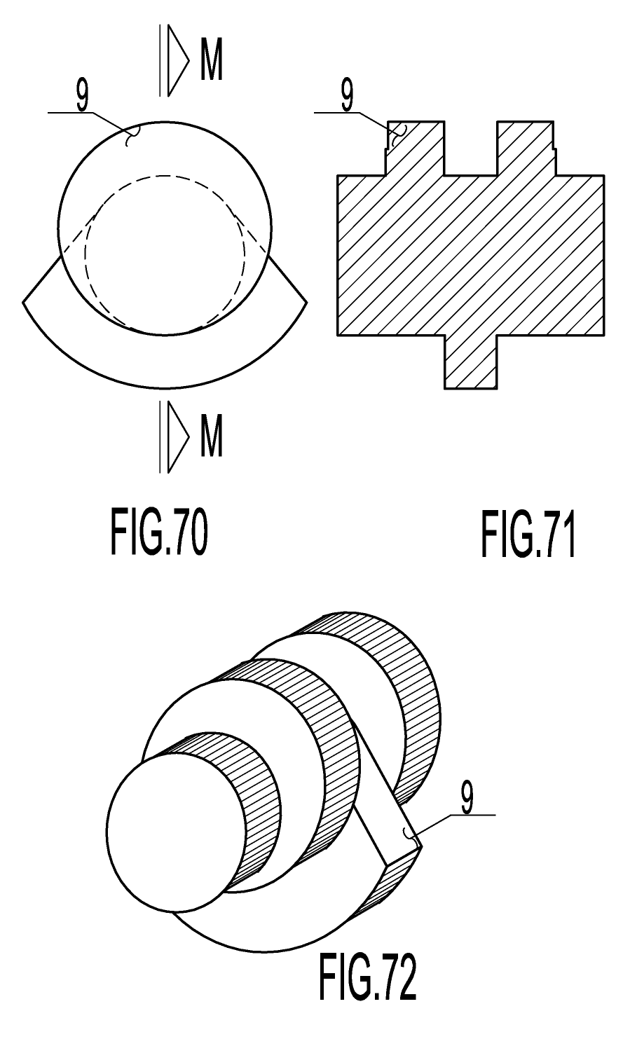

FIG. 70—General view of shuttle element.

FIG. 71—(M-M) section of shuttle element.

FIG. 72—Perspective view of shuttle element.

FIG. 73—Plan view of disk element.

FIG. 74—(N-N) section of disk element.

FIG. 75—Plan view of rivet element.

FIG. 76—(P-P) section at rivet element.

FIG. 77—Plan view field rivet.

FIG. 78—(R-R) section of field rivet.

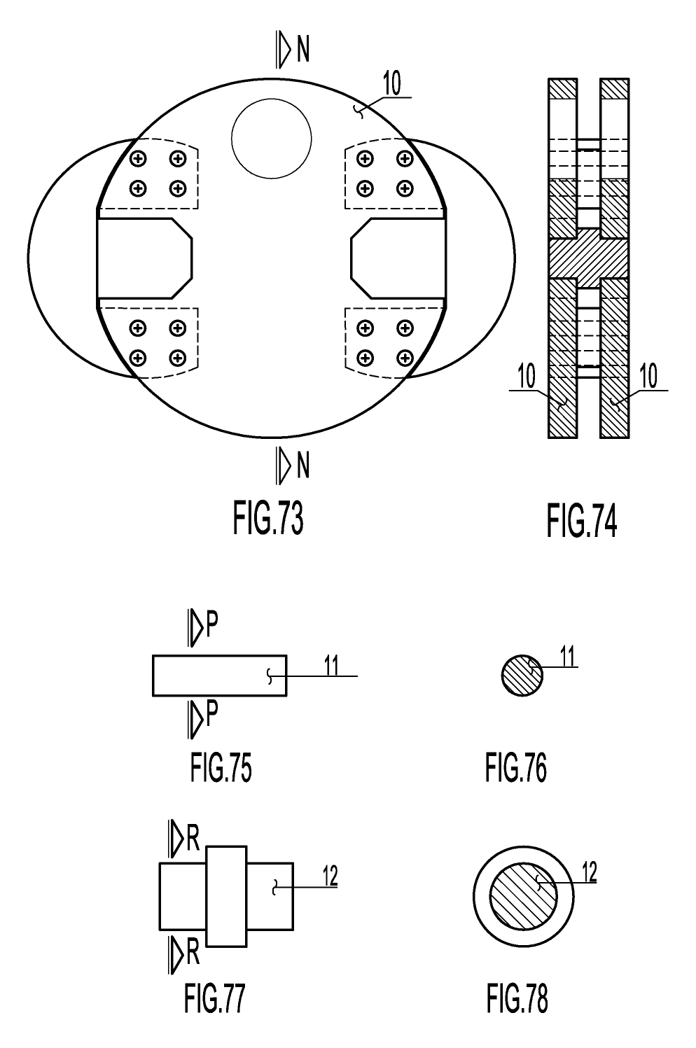

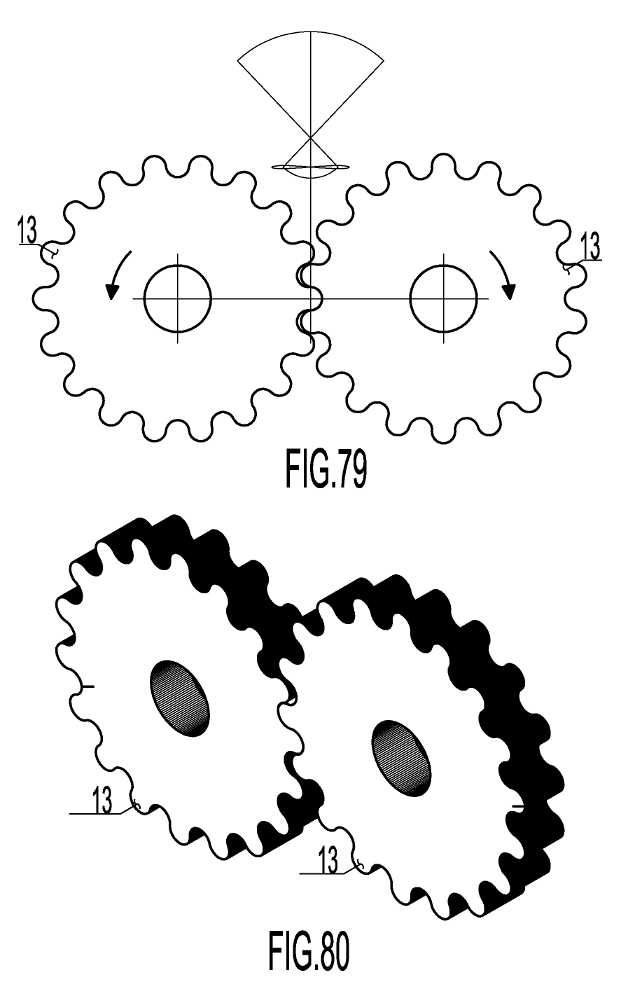

FIG. 79—Plan view of gear elements.

FIG. 80—Perspective view of gear elements.

FIG. 81—General view of sliding bearing.

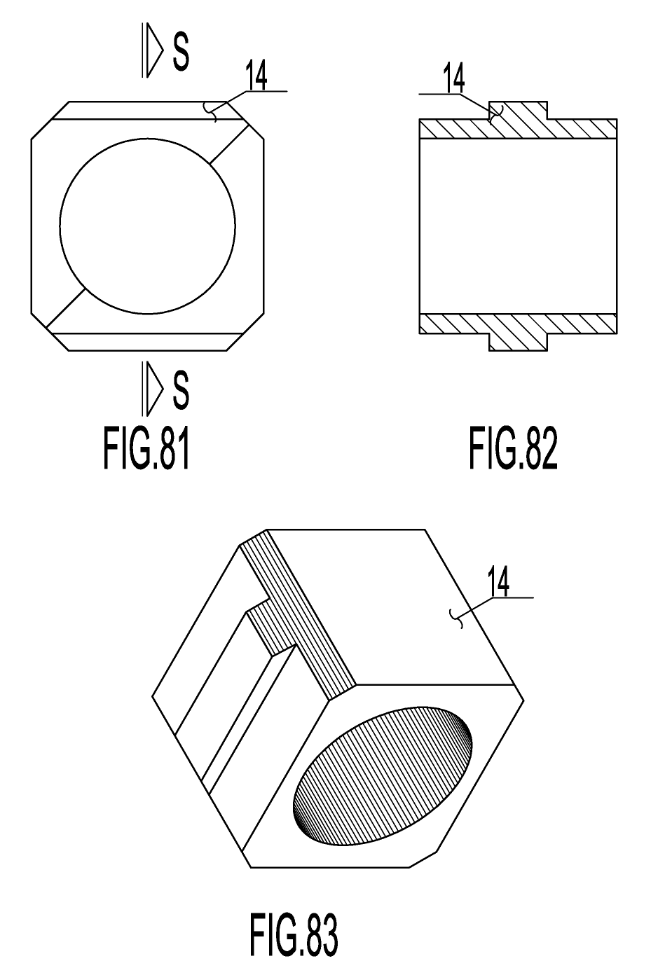

FIG. 82—(S-S) section of sliding bearing.

FIG. 83—Perspective view of sliding bearing.

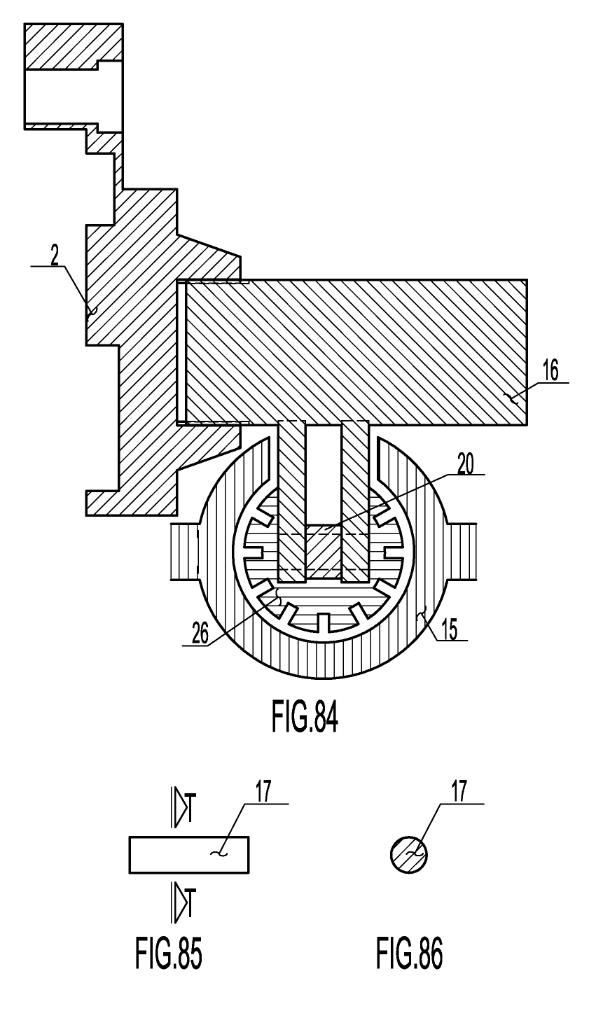

FIG. 84—Section view of circular cylinder, piston axis mile and oil driver.

FIG. 85—Plan view of connecting pin.

FIG. 86—(T-T) section of connecting pin.

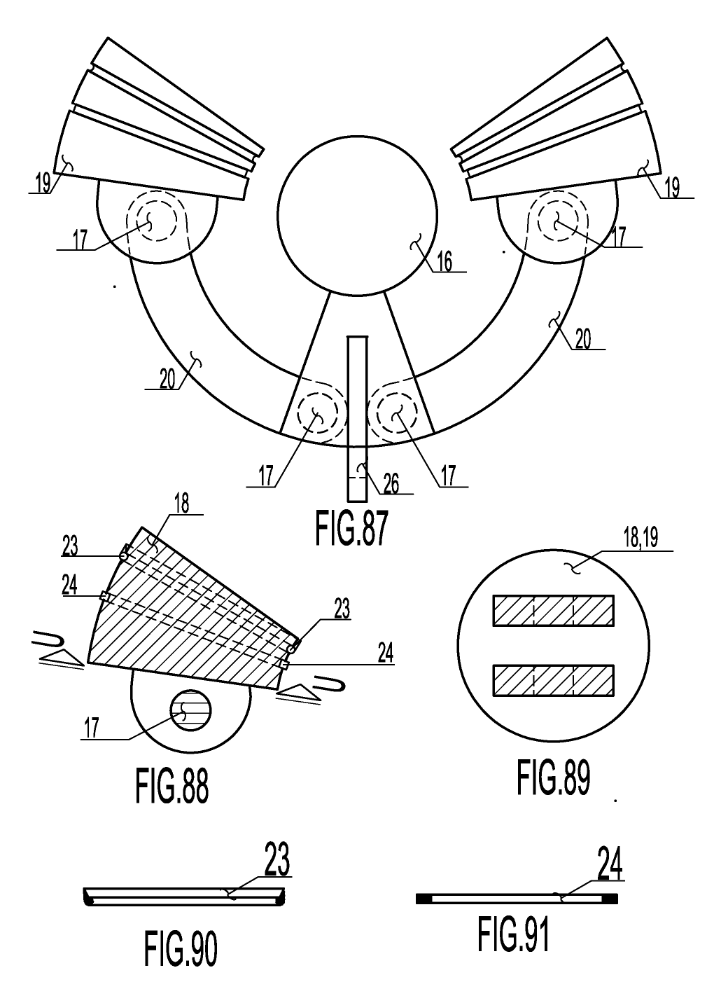

FIG. 87—Plan views of piston, piston axis mile, circular piston cranks, connection pins and oil driver.

FIG. 88—Section piston, pressure pad and oil seal.

FIG. 89—(U-U) section of piston.

FIG. 90—Sectional view of pressure pad.

FIG. 91—Sectional view of oil seal.

FIG. 92—General view of piston air shuttle, adjustment element.

FIG. 93—General view of pressure seal of piston air shuttle.

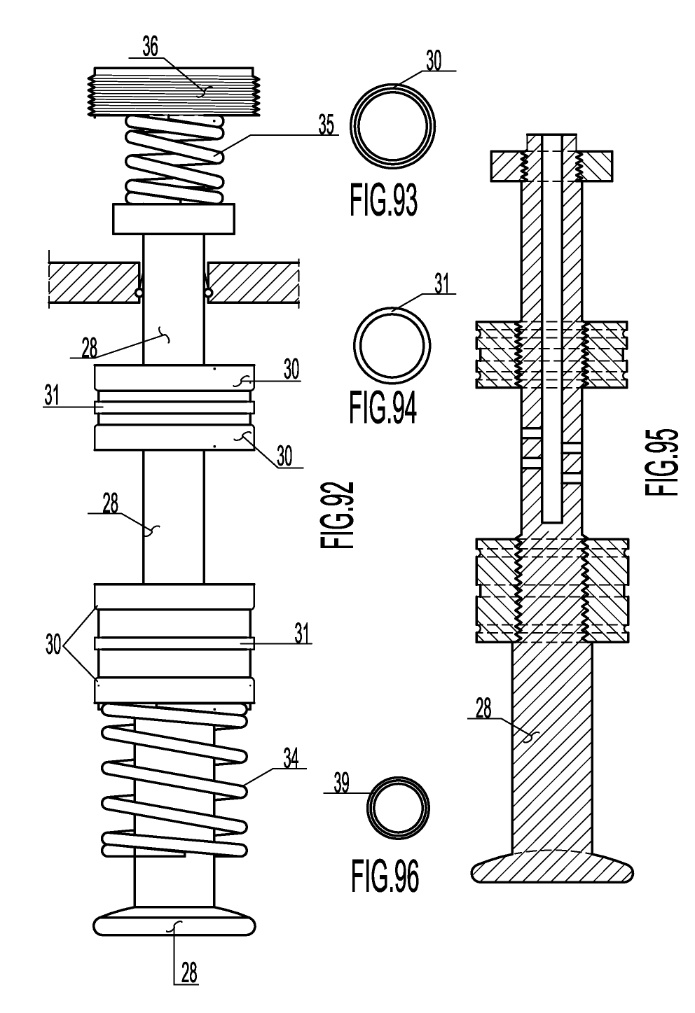

FIG. 94—General view of oil seal of piston air shuttle.

FIG. 95-Sectional view of reciprocating piston air shuttle.

FIG. 96—General view of contact element of piston air shuttle.

The parts in the figures above are assigned numbers as follows.
1. Assembly box
2. Hammer element
3. Eccentric element
4. Auxiliary eccentric element
5. Auxiliary hammer element
6. Fixing screw
7. Intermediate arm
8. Anchor pin
9. Shuttle element
10. Disc element
11. Rivet
12. Field rivet
13. Gear
14. Sliding bearing
15. Circular cylinder
16. Piston axis mile
17. Connection pin
18. Piston P1
19. Piston P2
20. Circular piston cranks
21. Cylinder chambers S1
22. Cylinder chambers S2
23. Pressure pad
24. Oil seal
25. Engine lubricant
26. Oil driver
27. Compressed air reservoir
28. Piston air shuttle
29. Cylinder bearing
30. Pressure seal
31. Oil seal
32. Air pressure channel
33. Air pressure channel
34. Piston pressure spring
35. Resistance spring
36. Sensitive adjustment screw
37. Pressure chamber
38. Compressed air entrance chamber
39. Contact element
40. Valve element
41. Valve element
42. Valve element
43. Valve element
44. Electric motor
45. Valve coil
46. Valve nucleus
47. Valve nucleus spring
48. Cylinder connection tube
49. Valve coil
50. Valve nucleus
51. Valve nucleus spring
52. Valve coil
53. Valve nucleus
54. Valve nucleus spring
55. Cylinder connection tube
56. Valve coil
57. Valve nucleus
58. Valve nucleus spring
59. Piston
60. Connecting rod
61. Cranking motor
62. Cylinder
63. Plug

The power production apparatus from compressed gas by the principle of moment of inertia is a mechanical system in a closed assembly box(1).

The shaft of two hammer element(2) two eccentric element(3) and auxiliary eccentric element(4) of this apparatus are outside the assembly box(1) accordingly. A linear force is applied by auxiliary hummer element(5) which can be assembled on either one side or both sides of the shaft of the hammer element(2) on both sides of assemble box(1). This applied force which works with leverage principle is converted to rotational motion within (87°) angle by the hammer element(2) which is assembled by fixing screw(6). The revolving movement of auxiliary eccentric element(4) with intermediate arm(7) with the anchor pin(8) is connected to the hammer element(2). This connection has two purposes, which are the first purpose is to keep the oscillation movement of hummer element(2) within oscillation angle(87°) and the second purpose is to transmit the rotational motion applied on auxiliary eccentric element(4) to hammer element(2) as a linear force. The oscillation motion created by the hammer element(2) is by the shuttle element(9), via eccentric element(3) transmitted to disk element(10).

The shuttle element(9) which combines the these two types of movement is in the center of hammer element(2) and eccentric center makes the movement of closed diagram with the option of two side with clock-wise and reverse accordingly the movement of disc element(10). While these diagram movement occurs, if a force is applied to reverse direction to the hummer element(2) which is making an angle of (15.5°) with spin-off axle, eccentric center, sliding support becomes a crowbar as a heavy lift and forces a reverse power back on shuttle element(9). With this forced power, spin-off movement of hummer element(2) keeps going till the point of intersection of axle for pin spin-off. The disc element(10) that fixes with four pieces rivets (11 and 12) are spined-off and distributed the force directly to eccentric element(3). Since the fixed and contact gears(13) at the ends of eccentric elements(3) rotates in the opposite direction eccentric elements(3) also rotates in the opposite direction. The distance of the rotation centers of the disk element(10) changes the distance of the eccentric centers at the diagonal position of the eccentric elements(3) at the diagonal position which rotates in the opposite direction. For this reason it is compulsory to use sliding bearing(14) at the rotation center of the disk element(10). While eccentric elements(3) rotate in the opposite direction, the eccentric centers takes their relative positions in the same direction which is on a straight line. At this position the eccentric element(3) and rotation centers of disk element(10) coincides. While eccentric centers of the eccentric element(3) which rotates 180° in clock-wise direction, there becomes sliding of the other center and their positions are in reverse order when compared to the starting position. During the opposite rotational motion as eccentric center of the eccentric element(3) is fixed after 180° counter clock-wise rotation, there becomes a sliding at the other center. As these actions continue, the disk element(10) complete rotational motion with two center, and moment of inertia force is created with the movement of its mass. This created force is directly transferred to eccentric elements(3) and produced energy in order to upscale the revolving movement. The power is generated without increasing the linear force applied to the apparatus on energy is saved by decreasing the linear forge applied.

The conversion of potential energy of compressed gas to kinetic energy is a cekieved with a closed system compressor which works together with the power production apparatus with moment of inertia principle. This closed system compressor can be on both sides or only on one side of the apparatus The closed system compressor has circular cylinder(15) and in the midst of there is the piston axis mile(16) which moves together with hammer element(2). Connection pins(17) in order to help the transfer oscillation moment to the pistons(18 and 19), have been used for the assembly of circular piston rods(20). Circular piston cranks(20) compresses pressured air to (S1) cylinder(21) with (P1) piston(18) and to (S2) cylinder(22) with P2 piston(19). While these pistons(18 and 19) with pressure pad(23) and oil seal(24) move within (87°) oscillation, the distribution of the machine lubricant (25) on the circular cylinder(15) is a cekieved with the oil driver(26). The entrance end exit of compressed air to cylinder chambers(21 and 22) from compressed air reservoir(27) becomes possible with the movenert of air shuttle(28). Air shuttle with pistons(28) is in the cylinder bearing(29) and contains pressure seal(30) oil seal(31). It is connected with the air channels (32 and 33) and pressures are the same on both sides. The movement of the piston air shuttles(28) in the direction of pressured air channel(32) is controlled with piston pressure spring(34). The strength of this piston pressure spring(34) is controlled and regulated by the resistance spring(35) and sensitive adjustable screw(36). In cylinder bearing(29). The pressure is equal in the compressed air reservoir(27) no matter irohot the volume is except pressure chamber(37) and compressed air entrance chamber(38). Piston air shuttle(28) is in contact with contact element(39) and is closed position. Opening action of shuttle(28) air is realised by valve elements(40 and 41) which is connected to air pressure channel(33) and closing action of air shuttle is realised by valve elements (42 and 43) which is connected pressure chamber(37) and cylinder chambers(21 and 22).

P1(18) and P2(19) piston that are connected to hammer element(2) activated by the electric motor(44) on auxiliary eccentric element(4). When P1 piston(18) passes through (71.5°) angle in clock-wise direction, when the coil(45) is induced by the energy from the central control system the nucleus(46) is pulled out and let the pressured air(33) to flow to valve(40) in between compressed air duct(33) and pressure chamber(37). Compressed air fills pressure chamber(37) and when pressures are the same, connection is terminated by nucleus spring(47) pressure. The pressure of the compressed air in the pressure chamber(37) pushes the piston air shuttle (28) in the direction of the air pressure channel(32). The compressed air which fills S1 cylinder(21) through the connection tube(48) which is connected with the compressed air entrance chamber(38) of piston air shuttle(28) exerts a pressure on P1 piston(18) while it passes through)(71.5° oscillation angle. At this position, the disk element(10) of the apparatus moves by taking the center of shuttle element(9) as rotation axis.

As the shuttle element(9) completes its action it is a kind of leverage where the eccentric center is the sliding support and rotation center is the load end. When the produced opposite force at shuttle element(9) starts to compress certain amount of air in cylinder(21) to fill in pressure reservoir (27) with P1 piston(18) which is connected to hammer element(2) and piston axis mile(16) the accelerated disc element(10) makes skidding action start with two centered motion and produces the movement which is directly connected to revolving movement of eccentric element(3). When P1 piston (18) completed the oscillation motion, the cragy coming to valve(42) in between pressure chamber(37) and (S2) cylinder(22) induce the reel(49) and when the nucleus(50) of the induced reel is pulled and compressed air in pressure chamber(37) flows through to (S2) cylinder(22). When the pressure of the pressure chamber(37) decreases then nucleus spring(51) exerts a pressure and connection with (S2) cylinder(22) is cut. When the (P1) piston(18) completes its oscillation it start to move counter clock-wise direction with the opposite force created by the compressed air remained in cylinder and movement moment of disc element(10). The energy coming on valve(41) between pressured air channel(33) and pressure chamber(37) while P2 piston(19) passing through (71.5°) angle in canter clock-wise direction, induces the reel the induced reel(52) pulls the nucleus(53) and releases the compressed air in the air pressure channel(33). Compressed air fills the pressure chamber(37) and when the pressures become equal connection is cut with the pressure of nucleus spring(54). The pressure created by the pressure in the pressure chamber(37) pushes the air shuttle (28) in the direction of pressured air channel(32). The compressed air fills (S2) cylinder(22) though the connection tube(55) which is in connection with the in fill chamber(38) of air shuttle(28). The compressed air in (S2) cylinder(22) exerts a pressure on P2 piston(19) as it passes (71.5°) oscillation angle. At this stage the disc element(10) of the apparatus makes the shuttle element start by taking the center of shuttle element(9) as the

center of rotation. While the shuttle element(9) is a achieving this action, it acts as a leverage such that its eccentric center is sliding support and its rotation center is load end. When the produced opposite force at shuttle element(9) starts to compress certain amount of air in cylinder(22) to fill in pressure reservoir(27) with P2 piston(19) which is connected to hammer element(2) and piston axle mile(16) the accelerated disc element(10) makes skidding action start with two centered motion and produces the movement which is directly connected to revolving movement of eccentric element(3).

When P2 piston(19) completed the oscillation motion, the cragy valve(43) coming to between pressure chamber(37) and the induced S1 cylinder(21) and when the induced coil(56) of the induced nucleus(57) is pulled and compressed air in pressure chamber(37) flows through to S1 cylinder(21). When the pressure in pressure chamber(37) decrease the nucleus spring(58) exerts pressure and connection to S1 cylinder(21) is cut. P2 piston(19) starts to move in clock-wise direction with the aid of pushing action of compressed air generated by disk element(10) after its oscillation is completed and spins off with the effect of revolving movement generated by motion moment. As these actions continue the volume and pressure of the chamber(27) becomes fixed.

The time of rotation is not fixed and can be archived what ever tour time is desired; Since the magnitude of skidding in creases with the amount of air which will be compressed in cylinders(21 and 22) it is necessary to control the volume of air to be compressed. The control of compressed or possible with the valve elements(40,41,42 and 43). When the pistons(18 and 19) are between (80°-85°) angle, the valve element(40 and 41) between air pressure channel(33) and pressure chamber(37) is opened and the volume of air which will be compressed in cylinder(21 and 22) will be decreased. Since the volume of air compressed is decreased the opposite force becomes lower and since the rotation time becomes longer rotational motion becomes slower.

If the valves(40 and 41) between air pressure channel(33) and pressure chamber(37) is opened and then the depletion valves(42 and 43) of pressure chamber(37) is opened and closed during depletion time while the piston axis(18 and 19) passes through 71.5° oscillation angle the volume of compressed air in cylinders(21 and 22) will be bigger in size. And the force of pistons(18 and 19) pressure spring(34) will be added to created opposite pressure. For this reason sliding force will increase and rotation will be accelerated since rotation time of compressor system of the apparatus is decreased. Since the potential energy of compressed gas is converted to rotational motion, the new apparatus has reached its purpose.

The apparatus of movement motion of compressed gas, the apparatus of produced movement motion; crank shaft used in this apparatus which makes rotation possible from linear force is used in all kinds of machines.

With one apparatus a machine with one, two or four cylinder system is produced.

For greater capacity machines additional apparatus must be taker into consideration. Who power production apparatus is applied in machines which works with combustion principle, maximum output is obtained.

The characteristics of a combustion type machine with one cylinder produced with this power production apparatus; to reproduce energy from recyclable sources is possible with the combination of electrical motors used in sea, air and motorway machines with system used to produce energy.

The specification of combustion type machine with one cylinder; auxiliary hammer element(5) is assembled to the axis of hammer element (2) of the power production apparatus which can be connected at any angle desired. At the piston's(59) connecting rods(60) is connected to auxiliary hammer element(5) with anchor pin(8) depending open the volume requested to produce. The machine which gathered the revolving force with cranking motor(61), start to compress the air-fuel mixture to its cylinder(62) with its piston(59). When piston(59) reaches 15.5° angle, air-fuel mixture burns with the energy at plug(63) and exerts a pressure on piston(59). The piston(59) distributes the power to the disc element(10) with shuttle element(9) which is on the tip of hummer element(2). Disc element(10) distributes the motion movement force which is gathered by revolving movement with two centers to eccentric element(3) as revolving movement and starts the movement to and reverse clock-wise of shuttle element(9) which is connected to itself. The disc element(10) makes the shuttle element(9) to move in clock-wise in counter clock-wise direction. Also eccentric element(3) while shuttle element(9) achieves this action it acts as a leverage and this leverage produces reverse force equal to the pressure gathered by the expansion in the cylinder(62). Piston(59) to complete its 15.5 angle spin-off movement, puts the pressure on the expansed air in the cylinder(62) which makes the pressure higher and this leads the reverse power and revolving movement accelerates through the process. The piston(59) that completed its spin-off movement keeps revolving while spinning off with the force of highly pressed air. As a result of this process, on the engine which uses powering up material, decreasing the volume of cylinder(62), can cause economical usage of energy.

1. A mechanical device; having the characteristics of the power production apparatus with moment of inertia of a mechanical set-up that has been placed inside a closed assembly box(1); the transmission of the rotating motion that has been applied as a linear strength through the intermediate arm(7) over the anchor pin(8) and the hammer element(2) to the auxiliary eccentric element(4) and the transmission of the linear strength that had been applied on to the auxiliary hammer element(5) to the hammer element(2) again, in which the transformation into oscillatory motion of the linear strength that had been applied is provided by the hammer element(2) operating in accordance whit the principle of leverage and that has been installed to each other with the fixing screw(6); providing the transmission of the oscillatory motion that has been produced to the disc element(10) that has been integrated whit the rivets(11 and 12) that consists of four parts and are involved in bi-centric kinesis motion using the shuttle element(9) at the load edge of the hammer element(2); to provide the rotation of the eccentric elements(3) with the contacting gears(13) at their edges in the opposite direction; to provide for the eccentric elements(3) to give the bi-centric kinesis motion to the disc element(10) that is dependent on its motion; since the rotation central distances of the disc element(10) is also changed with the change in the eccentric central distance at the diagonal position of the eccentric element (3) that rotates in opposite directions, the resolution had been provided by applying sliding bearing(14) to the rotation centers of the disc element(10); the disc element(10) receiving its motion from the eccentric element(3) is provided with a bi-centric kinesis motion during the rotating motions of the eccentric element(3) of 180 degrees in the clock-wise and anticlockwise directions starting from the horizontal position, by being hurled to one of the eccentric elements(3) and during the second rotation motion with 180 degrees; being hurled to the other eccentric element(3) where by creating the moment of inertia; with the direct reflection of the created moment of inertia to the eccentric element(3) where by the energy that has been produced is increased.

2. Placed at minimum intermediate arm(7) distance at the right or left of hammer element(2), auxiliary eccentric element(4) of apparatus generating power by moment of inertia which is a mechanical set up placed within closed assembly box(1) according to claim 1, is an eccentric shaft providing to transmit the rotating motion applied to the apparatus to the hammer element(2) as a linear force with the intermediate arm(7).

3. Intermediate arm(7) located between the auxiliary eccentric element(4) and hammer element(2) of apparatus generating power by moment of inertia which is a mechanical set up placed within closed assembly box(1) according to claim 1, is the connection element providing to transmit the revolving motion applied to the apparatus to the hammer element(2) as a linear force.

4. Auxiliary hammer element(5) of apparatus generating power by moment of inertia which is a mechanical set up placed within closed assembly box(1) according to claim 1, functions with leverage principles and is the element providing the applied linear force to be perceived as an oscillating motion since it is linked to the shaft of hammer element(2) and provide it to be transmitted to the hammer element(2).

5. Hammer element(2) of apparatus generating power by moment of inertia which is a mechanical set up placed within closed assembly box(1) according to claim 1, which functions with leverage principles is the element which provides to convert the linear force received by it with the intermediate arm(7) through the anchor pin(8) from the auxiliary hammer element(5) or auxiliary eccentric element(4) transmit to oscillation motion and to transmit the oscillation motion to the disc element(10) with the shuttle element(9) connected to it.

6. Shuttle element(9) at the load end of the hammer element(2) of apparatus generating power by moment of inertia which is a mechanical set up placed within closed assembly box(1) according to claim 1, is an eccentric shaft to provide the transmission of pressure force to the disc element(10) with motions in clockwise and counter clock-wise direction while transferring the oscillation motion of the hammer element(2) to closed diagram motion drawn by the center of shuttle element(9) slot on the disc element(10).

7. Disc element(10) of apparatus generating power by moment of inertia which is a mechanical set up placed within closed assembly box(1) according to claim 1, is the element which takes its first motion from the hammer element(2) through shuttle element(9) and provides to form moment of inertia force by driving with bi-centric motion continued depending on opposite rotating motions of eccentric element(3) linked with sliding bearing(14).

8. Sliding bearing(14) at the disc element(10) of apparatus generating power by moment of inertia which is a mechanical set up placed within closed assembly box(1) according to claim 1, are the elements which provide to be bed to bi-directional motion with opposite rotating of the eccentric element(3) and because of change of eccentric center distances and disc element(10) rotation center distances.

9. Eccentric elements(3) of apparatus generating power by moment of inertia which is a mechanical set up placed within closed assembly box(1) according to claim 1, are the elements which provide the bi-centric motion of disc element(10) with rotation motion dependent to one of the eccentric elements(3) in 180 degree rotation motion from the horizontal position and to the other eccentric element(3) in the second 180 degree rotation while rotating the reverse direction with the motion of gears (13) that it is dependent.

10. Each one of gears(13) of apparatus generating power by moment of inertia which is a mechanical set up placed within closed assembly box(1) according to claim 1, is the element which is fixed in an eccentric element(3) and provides the same motion to its eccentric elements(3) while they are rotating in opposite directions due to the reason that they touch each other.

11. Rivets(11 and 12) of apparatus generating power by moment of inertia which is a mechanical set up placed within closed assembly box(1) according to claim 1, are round metal elements which provide the connection of disc element(10) composed of four pieces.

12. This is a mechanical set-up with the characteristics of the closed circuit compressor of the power production apparatus with moment of inertia using the compressed gasses in accordance with claim ‘1; where the same has been provided with the characteristics that are appropriate for the working principles of the power production apparatus with moment of inertia; the oscillatory motions is conveyed to the pistons(18 and 19) that are equipped with the pressure pad(23) and the oil seal(24) via the circular piston cranks(20) that are in relation to the piston axis mile(16) and the connection pin(17) to the said mile(16) in the middle of the circular cylinder (15); the engine lubricant(25) is distributed in a homogeneous order to the surfaces of the circular cylinder(15) with the oil driver(26); the entrance and exit of the compressed air in the compressed air reservoir(27) to the cylinder chambers(21 and 22) has been provided by the air shuttles(28) and the valve elements(40,41,42 and 43) supporting the same; the pistons (18 and 19) that are dependent of the motion of the hammer element(2) provide for the release of the compressed air that had been filled into the cylinders(21 and 22) during their passage with the oscillatory motion of 71.5 degrees with the opposite force; the compression motion had been continued until the oscillatory angle had been completed, the pressure and the volume of the air in its reservoir(27) and had been maintained; the closed circuit compressor providing its motion in connection with the hammer element(2); with is functions that are in conformance with the working principles of the apparatus; providing the functions of a two stroke, two cylinders piston engine.

13. Circular cylinder(15) of closed circuit compressor of apparatus generating power by moment of inertia from compressed gases according to claim 1, works as bed to pistons(18 and 19) and provides the formation of chambers to compress the forced air.

14. Piston axis mile(16) of closed circuit compressor of apparatus generating power by moment of inertia from compressed gases according to claim 1, is the element which provides to transmit the oscillation motion of the hammer element(2) to the pistons(18 and 19) at the end of circular piston cranks(20) linked to it (16) and provides its bi-directional oscillation motion.

15. connection pin(17) of closed circuit compressor of apparatus generating power by moment of inertia from compressed gases according to claim 1, is the element which provides the connection of circular piston cranks(20) to pistons(18 and 19) and piston axis mile(16) with joints.

16. Circular piston cranks(20) of closed circuit compressor of apparatus generating power by moment of inertia from compressed gases according to claim 1, are transmission arms which provide the transmission of oscillation motion of piston axis mile(16) to the pistons(18 and 19) as linear motion.

17. Pistons(18 and 19) of closed circuit compressor of apparatus generating power by moment of inertia from compressed gases according to claim 1, are equipped with pressure pad(23) and oil seal(24) and has the property of providing compression of air in cylinder chamber(21 and 22) by reciprocating motions.

18. Pressure pad(23) of pistons(18 and 19) of closed circuit compressor of apparatus generating power by moment of inertia from compressed gases according to claim 1, is the element which provides to keep the compressed air under pressure without reducing its pressure.

19. Oil seal(24) of pistons(18 and 19) of closed circuit compressor of apparatus generating power by moment of inertia from compressed gases according to claim 1, is the element which provides the lubrication of friction surfaces to prevent abrasion and power loss of the piston(18 and 19) with reciprocating motion and pressure pad(23).

20. Oil driver(26) of closed circuit compressor of apparatus generating power by moment of inertia from compressed gases according to claim 1, is on the piston cranks(20) and is the element which provides the distribution of engine lubricant(25) on the friction surface of circular cylinder(15) pistons(18 and 19).

21. Compressed air reservoir(27) of closed circuit compressor of apparatus generating power by moment of inertia from compressed gases according to claim 1, is a closed volume which provides keeping the compressed air needed by the closed circuit compressor to make oscillation motion.

22. The characteristics of the closed circuit compressor of the power production apparatus with moment of inertia using the compressed gasses in accordance with claim 1; the connection of the piston air shuttle (28) with the pressure air channels (32 and 33) on both sides has been provided by piston pressure spring(34), resistance spring(35) and sensitive adjustment screw(36); that is at complete contact with the contact element(39) the motion of the piston air shuttle(28) has been realised by the pressure chamber(37) that has been triggered with the valve elements (40,41,42 and 43); where the motion inside the cylinder bearing(29) is provided by being equipped with a pressure seal(30) and oil seal(31); providing the functions of filling and emptying of the air with pressure into the cylinder chambers(21 and 22).

23. Cylinder bearing(29) of piston air shuttle(28) of closed circuit compressor of apparatus generating power by moment of inertia from compressed gases according to claim 1, is the element on the body of closed circuit compressor which is in the center relevant with its purpose to be the bed in the motions of piston air shuttle(28).

24. Pressure seal(30) of the piston air shuttle(28) of closed circuit compressor of apparatus generating power by moment of inertia from compressed gases according to claim 1, is the element which provides the prevention of change in compressed air volume and pressure to the chambers.

25. Oil seal(31) of the piston air shuttle(28) of closed circuit compressor of apparatus generating power by moment of inertia from compressed gases according to claim 1, is the element which provides the lubrication of friction surfaces of the piston air shuttle(28) and its pressure seal(30) and pistons moving in the cylinder bed in order to reduce the friction loss.

26. Piston pressure spring(34) of piston air shuttle(28) of closed circuit compressor of apparatus generating power by moment of inertia from compressed gases according to claim 1, is the element which provides bi-directional resistance in the motion and fixation of the piston air shuttle(28).

27. Resistance spring(35) of piston air shuttle(28) of closed circuit compressor apparatus generating power by moment of inertia from compressed gases according to claim 1, is the element which provides to reduce resistance of piston pressure spring(34) and fix the volume of pressure chamber(37).

28. Sensitive adjustment screw(36) of piston air shuttle(28) of closed circuit compressor of apparatus generating power by moment of inertia from compressed gases according to claim 1, is the element which provides the adjustment of opening and closing of piston air shuttle(28) according to the rotation time.

29. Pressure chamber(37) of piston air shuttle(28) of closed circuit compressor of apparatus generating power by moment of inertia from compressed gases according to claim 1, is the small air tank which provides the movement of piston air shuttle(28) by filling and emptying of compressed air.

30. Contact element(39) of piston air shuttle(28) of closed circuit compressor of apparatus generating power by moment of inertia from compressed gases according to claim 1, is the element which provides the prevention of leakage of compressed air by contacting the piston air shuttle(28).

31. Valve element (40 and 41) of closed circuit compressor of apparatus generating power by moment of inertia from compressed gases according to claim 1, is the electro-mechanical element which motion with time adjustable electric energy from central control center and which provides the filling of compressed air to the pressure chamber (37) of piston air shuttle(28).

32. Check valve element (42 and 43) of closed circuit compressor of apparatus generating power by moment of inertia from compressed gases according to claim 1, is the electro-mechanical element which motion with time adjustable electric energy from central control center and which provides the emptying and preventing return of compressed air from the pressure chamber (37) of piston air shuttle (28).
